(19) United States
(12) Patent Application Publication
(10) Pub. No.: US 2026/0145419 A1
(43) Pub. Date: May 28, 2026

(54) LIQUID EJECTING APPARATUS, HEAD UNIT, AND INSPECTION METHOD FOR LIQUID EJECTING APPARATUS

(71) Applicant: SEIKO EPSON CORPORATION, Tokyo (JP)

(72) Inventors: Kazunari TSUKADA, Matsumoto (JP); Toru MATSUYAMA, Matsumoto (JP); Daichi ORIHARA, Shiojiri (JP)

(21) Appl. No.: 19/399,710

(22) Filed: Nov. 25, 2025

(30) Foreign Application Priority Data
Nov. 27, 2024 (JP) 2024-206272

(51) Int. Cl. B41J 2/045

(52) U.S. Cl. CPC B41J 2/0451; B41J 2/0455; B41J 2/04551; B41J 2/04573; B41J 2/04581; B41J 2/04588; B41J 2/0459

(57) ABSTRACT

A liquid ejecting apparatus includes a first ejection section that is configured to eject a liquid in response to displacement of a first piezoelectric element by a drive signal; a second ejection section that is configured to eject the liquid in response to displacement of a second piezoelectric element by the drive signal; and an inspection section that inspects a state of the first ejection section based on a potential of the first piezoelectric element in an inspection period, the inspection section includes a first inspection mode, and a second inspection mode, the drive signal changes in potential from a first potential to a second potential in a second period, and maintains the second potential in a third period, following the second period, the third period includes the inspection period, and the second period is longer in the first inspection mode than in the second inspection mode.

The present application is based on, and claims priority from JP Application Serial Number 2024-206272, filed Nov. 27, 2024, the disclosure of which is hereby incorporated by reference herein in its entirety.

### BACKGROUND

### 1. Technical Field

The present disclosure relates to a liquid ejecting apparatus, a head unit, and an inspection method for the liquid ejecting apparatus.

### 2. Related Art

Liquid ejecting apparatuses such as ink jet printers drive a piezoelectric element provided in an ejection section with a drive signal and displace the piezoelectric element, thereby ejecting a liquid such as ink filled in the ejection section and executing a printing process of forming an image on a medium. However, in the liquid ejecting apparatuses, an ejection abnormality in which the liquid cannot be normally ejected from the ejection section may occur. When the ejection abnormality occurs, the image quality of the image formed at the medium in the printing process deteriorates. Therefore, a technique for inspecting the state of the ejection section is proposed in the related art. For example, JP-A-2018-047638 discloses a technique for inspecting the state of an ejection section based on the potential of a piezoelectric element provided in the ejection section.

However, in the related art, the piezoelectric element provided in the ejection section may vibrate when the piezoelectric element is driven by the drive signal. In this case, the potential of the piezoelectric element provided in the ejection section to be inspected may fluctuate, and the state of the ejection section may not be accurately inspected.

### SUMMARY

According to an aspect of the present disclosure, there is provided a liquid ejecting apparatus including: a first ejection section that includes a first piezoelectric element that is displaced in response to a drive signal and that is configured to eject a liquid in response to the displacement of the first piezoelectric element; a second ejection section that includes a second piezoelectric element that is displaced in response to the drive signal and that is configured to eject the liquid in response to the displacement of the second piezoelectric element; and an inspection section that, when the drive signal is supplied to the second piezoelectric element in a unit period, inspects a state of the first ejection section based on a detection signal according to a potential of the first piezoelectric element in an inspection period included in the unit period, in which the inspection section is configured to inspect the first ejection section in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, and a time length of the second period in the first inspection mode is longer than a time length of the second period in the second inspection mode.

According to another aspect of the present disclosure, there is provided a liquid ejecting apparatus including: a first ejection section that includes a first piezoelectric element that is displaced in response to a drive signal and that is configured to eject a liquid in response to the displacement of the first piezoelectric element; and an inspection section that, when the drive signal is supplied to the first piezoelectric element in a drive period included in a unit period, inspects a state of the first ejection section based on a detection signal according to a potential of the first piezoelectric element in an inspection period included in a unit period, in which the inspection section is configured to inspect the first ejection section in a plurality of inspection modes including: a first inspection mode in which the state of the first ejection section is inspected in a state in which the first ejection section is filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, the drive period does not include the inspection period and includes at least the second period, and a time length of the second period in the first inspection mode is longer than a time length of the second period in the second inspection mode.

According to another aspect of the present disclosure, there is provided a liquid ejecting apparatus including: a first ejection section that includes a first piezoelectric element that is displaced in response to a drive signal and that is configured to eject a liquid in response to the displacement of the first piezoelectric element; a second ejection section that includes a second piezoelectric element that is displaced in response to the drive signal and that is configured to eject the liquid in response to the displacement of the second piezoelectric element; and an inspection section that, when the drive signal is supplied to the second piezoelectric element in a unit period, inspects a state of the first ejection section based on a detection signal according to a potential of the first piezoelectric element in an inspection period included in the unit period, in which the inspection section is configured to inspect the first ejection section in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal changes in potential from a first potential to a second potential in a first transition period of the unit period, maintains the second potential in a maintenance period, following the first transition period, of the unit period, and changes in potential from the second potential to the first potential in a second transition period, following the maintenance period, of the unit period, the maintenance period includes the inspection period, and a time length of the first transition period in the first inspection mode is longer than a time length of the first transition period in the second inspection mode.

According to another aspect of the present disclosure, there is provided a head unit including: a first ejection section that includes a first piezoelectric element that is displaced in response to a drive signal and that is configured to eject a liquid in response to the displacement of the first piezoelectric element; a second ejection section that includes a second piezoelectric element that is displaced in response to the drive signal and that is configured to eject the liquid in response to the displacement of the second piezoelectric element; and a detection section that, when the drive signal is supplied to the second piezoelectric element in a unit period, detects a potential of the first piezoelectric element in an inspection period included in the unit period and supplies a detection signal according to a detection result to an inspection section that inspects a state of the first ejection section based on the detection signal, in which the inspection section is configured to inspect the first ejection section in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, and a time length of the second period in the first inspection mode is longer than a time length of the second period in the second inspection mode.

According to another aspect of the present disclosure, there is provided a head unit including: a first ejection section that includes a first piezoelectric element that is displaced in response to a drive signal and that is configured to eject a liquid in response to the displacement of the first piezoelectric element; and a detection section that, when the drive signal is supplied to the first piezoelectric element in a drive period included in a unit period, detects a potential of the first piezoelectric element in an inspection period included in the unit period and supplies a detection signal according to a detection result to an inspection section that inspects a state of the first ejection section based on the detection signal, in which the inspection section is configured to inspect the first ejection section in a plurality of inspection modes including: a first inspection mode in which the state of the first ejection section is inspected in a state in which the first ejection section is filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, the drive period does not include the inspection period and includes at least the second period, and a time length of the second period in the first inspection mode is longer than a time length of the second period in the second inspection mode.

According to another aspect of the present disclosure, there is provided a head unit including: a first ejection section that includes a first piezoelectric element that is displaced in response to a drive signal and that is configured to eject a liquid in response to the displacement of the first piezoelectric element; a second ejection section that includes a second piezoelectric element that is displaced in response to the drive signal and that is configured to eject the liquid in response to the displacement of the second piezoelectric element; and a detection section that, when the drive signal is supplied to the second piezoelectric element in a unit period, detects a potential of the first piezoelectric element in an inspection period included in the unit period and supplies a detection signal according to a detection result to an inspection section that inspects a state of the first ejection section based on the detection signal, in which the inspection section is configured to inspect the first ejection section in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal changes in potential from a first potential to a second potential in a first transition period of the unit period, maintains the second potential in a maintenance period, following the first transition period, of the unit period, and changes in potential from the second potential to the first potential in a second transition period, following the maintenance period, of the unit period, the maintenance period includes the inspection period, and a time length of the first transition period in the first inspection mode is longer than a time length of the first transition period in the second inspection mode.

According to another aspect of the present disclosure, there is provided an inspection method for a liquid ejecting apparatus including: a first ejection section that includes a first piezoelectric element that is displaced in response to a drive signal and that is configured to eject a liquid in response to the displacement of the first piezoelectric element; and a second ejection section that includes a second piezoelectric element that is displaced in response to the drive signal and that is configured to eject the liquid in response to the displacement of the second piezoelectric element, the inspection method including: when the drive signal is supplied to the second piezoelectric element in a unit period, inspecting a state of the first ejection section based on a detection signal according to a potential of the first piezoelectric element in an inspection period included in the unit period, in which the inspection of the state of the first ejection section is configured to be executed in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, and a time length of the second period in the first inspection mode is longer than a time length of the second period in the second inspection mode.

According to another aspect of the present disclosure, there is provided an inspection method for a liquid ejecting apparatus including: a first ejection section that includes a first piezoelectric element that is displaced in response to a drive signal and that is configured to eject a liquid in response to the displacement of the first piezoelectric element, the inspection method including: inspecting a state of the first ejection section based on a detection signal according to a potential of the first piezoelectric element in an inspection period included in the unit period when the drive signal is supplied to the first piezoelectric element in a drive period included in the unit period, in which the inspection of the state of the first ejection section is configured to be executed in a plurality of inspection modes including: a first inspection mode in which the state of the first ejection section is inspected in a state in which the first ejection section is filled with the liquid, and a second inspection mode in which the state of the first ejection section is inspected in a time shorter than that in the first inspection mode, the drive signal maintains a first potential in a first period of the unit period, changes in potential from the first potential to a second potential in a second period, following the first period, of the unit period, maintains the second potential in a third period, following the second period, of the unit period, changes in potential from the second potential to the first potential in a fourth period, following the third period, of the unit period, and maintains the first potential in a fifth period, following the fourth period, of the unit period, the third period includes the inspection period, the drive period does not include the inspection period and includes at least the second period, and a time length of the second period in the first inspection mode is longer than a time length of the second period in the second inspection mode.

According to another aspect of the present disclosure, there is provided an inspection method for a liquid ejecting apparatus including: a first ejection section that includes a first piezoelectric element that is displaced in response to a drive signal and that is configured to eject a liquid in response to the displacement of the first piezoelectric element; and a second ejection section that includes a second piezoelectric element that is displaced in response to the drive signal and that is configured to eject the liquid in response to the displacement of the second piezoelectric element, the inspection method including: when the drive signal is supplied to the second piezoelectric element in a unit period, inspecting a state of the first ejection section based on a detection signal according to a potential of the first piezoelectric element in an inspection period included in the unit period, in which the inspection of the state of the first ejection section is configured to be executed in a plurality of inspection modes including: a first inspection mode in which the state of the first ejection section is inspected in a state in which the first ejection section and the second ejection section are filled with the liquid, and a second inspection mode in which the state of the first ejection section is inspected in a time shorter than that in the first inspection mode, the drive signal changes in potential from a first potential to a second potential in a first transition period of the unit period, maintains the second potential in a maintenance period, following the first transition period, of the unit period, and changes in potential from the second potential to the first potential in a second transition period, following the maintenance period, of the unit period, the maintenance period includes the inspection period, and a time length of the first transition period in the first inspection mode is longer than a time length of the first transition period in the second inspection mode.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a sectional view for explaining an example of the structure of an ejection section.

FIG. 4 is a plan view illustrating an example of the disposition of nozzles in the ink jet printer.

FIG. 5 is a block diagram illustrating an example of a configuration of a head unit.

FIG. 6 is a timing chart for explaining an example of signals supplied to the head unit.

FIG. 7 is an explanatory view for explaining an example of the operation of the coupled state designation circuit.

FIG. 8 is a timing chart for explaining an example of signals supplied to the head unit.

FIG. 9 is an explanatory view for explaining an example of the operation of the coupled state designation circuit.

FIG. 10 is an explanatory view illustrating an example of the operation of the head unit.

FIG. 11 is an explanatory view illustrating an example of the operation of the head unit.

FIG. 12 is an explanatory view illustrating an example of the operation of the head unit.

FIG. 13 is an explanatory view illustrating an example of a detection potential signal.

FIG. 14 is an explanatory view illustrating an example of the detection potential signal.

FIG. 15 is an explanatory view illustrating an example of the detection potential signal.

FIG. 16 is an explanatory view illustrating an example of the detection potential signal.

FIG. 17 is an explanatory view illustrating an example of a detection potential signal according to a comparative example.

FIG. 18 is an explanatory view illustrating an example of the detection potential signal according to the comparative example.

FIG. 19 is an explanatory view for explaining an example of the operation of the coupled state designation circuit according to Modification Example 1.

FIG. 20 is a timing chart for explaining an example of signals supplied to the head unit in Modification Example 2.

### DESCRIPTION OF EMBODIMENTS

Hereinafter, embodiments for carrying out the present disclosure will be described with reference to the drawings. Meanwhile, dimensions and scales of each section are different from the actual ones as appropriate in each drawing. In addition, the embodiments described below are preferred specific examples of the present disclosure and are thus added with technically preferred various limitations, but the scope of the present disclosure is not limited to such embodiments unless a description for limiting the present disclosure is made in the following description.

### A. Embodiment

In the present embodiment, a liquid ejecting apparatus will be described by exemplifying an ink jet printer that forms an image on recording paper PP by ejecting ink.

### 1. Overview of Ink Jet Printer

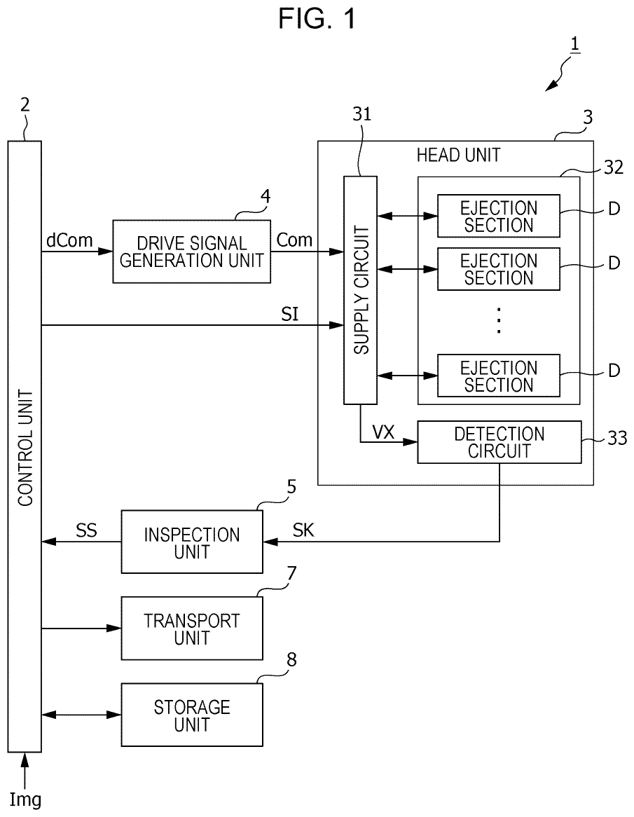

Hereinafter, an example of a configuration of an ink jet printer 1 according to the present embodiment will be described with reference to FIGS. 1 to 4.

FIG. 1 is a functional block diagram illustrating an example of a configuration of an ink jet printer 1.

As illustrated in FIG. 1, the ink jet printer 1 is supplied with print data Img indicating an image to be formed by the ink jet printer 1 from a host computer such as a personal computer or a digital camera. The ink jet printer 1 executes a printing process of forming the image, which is indicated by the print data Img supplied from the host computer, on the recording paper PP.

As illustrated in FIG. 1, the ink jet printer 1 includes a control unit 2 that controls each section of the ink jet printer 1, a head unit 3 provided with an ejection section D that ejects ink, a drive signal generation unit 4 that generates a drive signal Com for driving the ejection section D, an inspection unit 5 that inspects the state of the ejection section D, a transport unit 7 that changes the relative position of the recording paper PP with respect to the head unit 3, and a storage unit 8 that stores various information. The ink jet printer 1 is an example of a “liquid ejecting apparatus”, the ink is an example of a “liquid”, and the inspection unit 5 is an example of an “inspection section”.

In the present embodiment, it is assumed that the ink jet printer 1 includes one or a plurality of head units 3, one or a plurality of drive signal generation units 4 corresponding to the one or plurality of head units 3 on a one-to-one basis, and one or a plurality of inspection units 5 corresponding to the one or plurality of head units 3 on a one-to-one basis. Specifically, in the present embodiment, it is assumed that the ink jet printer 1 includes four head units 3, four drive signal generation units 4 corresponding to the four head units 3 on a one-to-one basis, and four inspection units 5 corresponding to the four head units 3 on a one-to-one basis. However, in the following, for convenience of description, as illustrated in FIG. 1, one head unit 3 of the four head units 3, one drive signal generation unit 4 of the four drive signal generation units 4 provided corresponding to the one head unit 3, and one inspection unit 5 of the four inspection units 5 provided corresponding to the one head unit 3 will be described.

The storage unit 8 is configured to include one or both of a volatile memory, such as a random access memory (RAM), and a non-volatile memory such as a read-only memory (ROM), an electrically erasable programmable read-only memory (EEPROM), or a programmable ROM (PROM), and stores a control program of the ink jet printer 1.

The control unit 2 is configured to include one or a plurality of central processing units (CPU). However, the control unit 2 may be provided with a programmable logic device such as a field-programmable gate array (FPGA) instead of the CPU or in addition to the CPU. The control unit 2 executes the control program stored in the storage unit 8 and operates in accordance with the control program to control each section of the ink jet printer 1.

Specifically, the control unit 2 generates a waveform designation signal dCom and supplies the generated waveform designation signal dCom to the drive signal generation unit 4. The waveform designation signal dCom is a digital signal that defines the waveform of a drive signal Com. The drive signal Com is an analog signal for driving the ejection section D. The drive signal generation unit 4 includes a DA converter circuit and generates the drive signal Com having the waveform defined by the waveform designation signal dCom. In the present embodiment, it is assumed that the drive signal Com includes a drive signal Com-A and a drive signal Com-B.

In addition, the control unit 2 generates a designation signal SI and supplies the generated designation signal SI to the head unit 3. The designation signal SI is a digital signal designating the type of operation of the ejection section D. Specifically, the designation signal SI is a signal that designates the type of operation of the ejection section D by designating whether or not it is driven by supplying the drive signal Com to the ejection section D.

When the printing process is executed, the control unit 2 generates a signal for controlling the head unit 3, such as the designation signal SI, based on the print data Img. In addition, when the printing process is executed, the control unit 2 generates a signal for controlling the drive signal generation unit 4, such as the waveform designation signal dCom. In addition, when the printing process is executed, the control unit 2 generates a signal for controlling the transport unit 7. Accordingly, the control unit 2 controls the transport unit 7 to change the relative position of the recording paper PP with respect to the head unit 3 in the printing process, adjusts the presence/absence of ink ejection from the ejection section D, the ejection timing of ink, and the like, and controls each section of the ink jet printer 1 to form an image corresponding to the print data Img on the recording paper PP.

As illustrated in FIG. 1, the head unit 3 includes a supply circuit 31, a recording head 32, and a detection circuit 33.

The recording head 32 includes M ejection sections D. Here, the value M is a natural number that satisfies “M≥2”. In the following, among the M ejection sections D provided in the recording head 32, the m-th ejection section D may be referred to as an ejection section D[m]. In this case, the variable m is a natural number that satisfies “1≤m≤M”. In addition, in the following, when a component, signal, or the like of the ink jet printer 1 corresponds to the ejection section D[m] among the M ejection sections D, a subscript [m] may be added to a symbol for representing the component, signal, or the like.

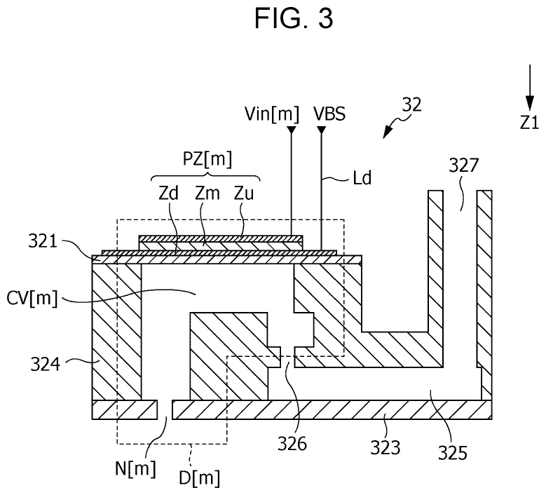

The supply circuit 31 switches whether to supply the drive signal Com to the ejection section D[m] based on the designation signal SI. In the following, among the drive signals Com, the drive signal Com supplied to the ejection section D[m] may be referred to as a supply drive signal Vin[m]. In addition, the supply circuit 31 switches whether or not to supply the detection potential signal VX[m] to the detection circuit 33 based on the designation signal SI. Here, the detection potential signal VX[m] is a signal indicating the potential of an upper electrode Zu[m] provided in a piezoelectric element PZ[m] included in the ejection section D[m]. In the following, when the detection potential signal VX[m] is supplied from the ejection section D[m] to the detection circuit 33, the ejection section D[m] may be referred to as an inspection target ejection section DK. The piezoelectric element PZ[m] and the upper electrode Zu[m] will be described below in FIG. 3.

The detection circuit 33 generates a detection signal SK[m] based on the detection potential signal VX[m] supplied from the ejection section D[m], which is set as the inspection target ejection section DK, via the supply circuit 31. Specifically, the detection circuit 33 generates the detection signal SK[m] by, for example, amplifying the detection potential signal VX[m] and removing a noise component. The detection circuit 33 is an example of a “detection section”.

The inspection unit 5 inspects the state of the ejection section D[m] designated as the inspection target ejection section DK based on the detection signal SK[m] supplied from the detection circuit 33, and outputs an inspection result signal SS[m] indicating the result of the inspection. In the present embodiment, it is assumed that the “inspection of the state of the ejection section D[m]” is a power storage capacity inspection. The power storage capacity inspection is the inspection of determining whether or not the piezoelectric element PZ[m] provided in the ejection section D[m] has a predetermined power storage capacity.

Here, the “predetermined power storage capacity” is, for example, the ability of the piezoelectric element PZ[m] to maintain the potential for a predetermined period when the upper electrode Zu[m] of the piezoelectric element PZ[m] is set to a desired potential by supplying the drive signal Com to the piezoelectric element PZ[m]. That is, the “when the piezoelectric element PZ[m] does not have a predetermined power storage capacity” is, for example, when an electrical short-circuit path is formed between the piezoelectric element PZ[m] of the ejection section D[m] and the piezoelectric element PZ of another ejection section D and a leak current flows through the short-circuit path, and as a result, the upper electrode Zu[m] of the piezoelectric element PZ[m] of the ejection section D[m] cannot maintain a desired potential for a predetermined period. Here, the “predetermined period” is, for example, a period in which the upper electrode Zu[m] of the piezoelectric element PZ[m] is to maintain a desired potential in the printing process in order to form an image indicated by the print data Img on the recording paper PP in the printing process. Specifically, the “predetermined period” may be a period corresponding to the drive cycle of the piezoelectric element PZ[m] by the drive signal Com, or may be a period shorter than the drive cycle of the piezoelectric element PZ[m] by the drive signal Com. In addition, the “maintain a desired potential” includes, for example, a case where substantially the same potential as the desired potential is maintained as well as a case where the same potential as the desired potential is maintained. Here, the “substantially the same potential as the desired potential” may be, for example, a potential that is considered to be the same when an error is taken into consideration.

When the piezoelectric element PZ[m] included in the ejection section D[m] does not have a predetermined power storage capacity, the potential of the upper electrode Zu[m] included in the piezoelectric element PZ[m] is set to a potential different from the potential defined by the drive signal Com. Therefore, when the piezoelectric element PZ[m] does not have a predetermined power storage capacity, the ejection section D[m] ejects an amount of ink different from the amount of ink defined by the drive signal Com, and the ejection section D[m] ejects the ink at a speed different from the ejection speed of the ink defined by the drive signal Com. Thus, when the piezoelectric element PZ[m] does not have a predetermined power storage capacity, the image quality of the image formed at the recording paper PP by the ink jet printer 1 deteriorates.

In the present embodiment, it is assumed that the state of the inspection target ejection section DK is inspected based on the detection potential signal VX[m] detected from the inspection target ejection section DK when a drive target ejection section DD is driven by the drive signal Com. Here, the drive target ejection section DD is an ejection section D different from the inspection target ejection section DK. In the present embodiment, as an example, it is assumed that the drive target ejection section DD is an ejection section D adjacent to the inspection target ejection section DK.

Hereinafter, a series of processes executed in the ink jet printer 1 for inspecting the state of the inspection target ejection section DK is referred to as an ejection section inspection process. Specifically, the ejection section inspection process is a series of processes including the inspection of the state of the inspection target ejection section DK and a preparation process, such as driving of the drive target ejection section DD to be executed for the inspection of the state of the inspection target ejection section DK.

When the ejection section inspection process is executed, the control unit 2 supplies the designation signal SI to the head unit 3. Accordingly, the control unit 2 designates the inspection target ejection section DK and the drive target ejection section DD from the ejection sections D[1] to D[M]. The control unit 2 controls the head unit 3 such that the drive target ejection section DD is driven by the drive signal Com, and then the detection potential signal VX[m] detected from the inspection target ejection section DK is supplied to the detection circuit 33. In addition, when the ejection section inspection process is executed, the detection circuit 33 generates the detection signal SK[m] based on the detection potential signal VX[m] detected from the inspection target ejection section DK. When the ejection section inspection process is executed, the inspection unit 5 inspects the state of the ejection section D[m] driven as the inspection target ejection section DK based on the detection signal SK[m] supplied from the detection circuit 33.

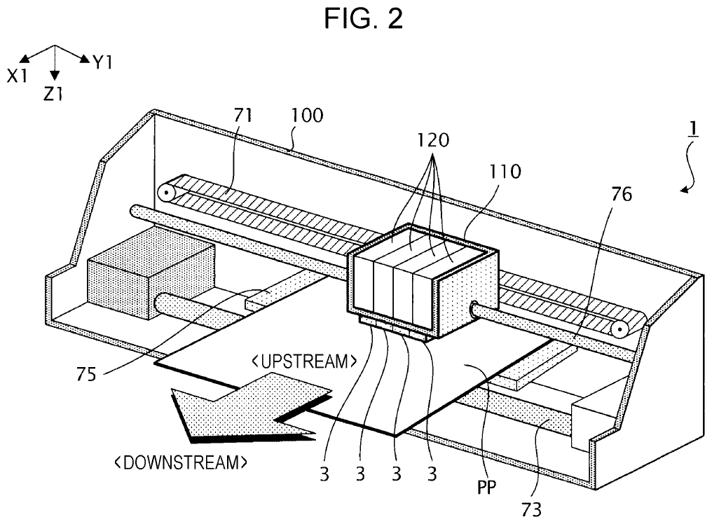

FIG. 2 is a perspective view illustrating an example of the schematic internal structure of the ink jet printer 1.

As illustrated in FIG. 2, in the present embodiment, it is assumed that the ink jet printer 1 is a serial printer. Specifically, when executing the printing process, the ink jet printer 1 ejects the ink from the ejection section D[m] while transporting the recording paper PP in an X1 direction and reciprocating the head unit 3 in a Y1 direction intersecting the X1 direction and a Y2 direction opposite to the Y1 direction, thereby forming dots Dt corresponding to the print data Img on the recording paper PP.

In the following, the X1 direction and an X2 direction opposite to the X1 direction are collectively referred to as an “X-axis direction”, the Y1 direction intersecting the X-axis direction and the Y2 direction opposite to the Y1 direction are collectively referred to as a “Y-axis direction”, and a Z1 direction intersecting the X-axis direction and the Y-axis direction and a Z2 direction opposite to the Z1 direction are collectively referred to as a “Z-axis direction”. In the present embodiment, as an example, a description will be made by assuming that the X-axis direction, the Y-axis direction, and the Z-axis direction are orthogonal to each other. However, the present disclosure is not limited to such an aspect. The X-axis direction, the Y-axis direction, and the Z-axis direction may intersect each other. In the present embodiment, the Z1 direction is a direction in which the ink is ejected from the ejection section D[m].

As illustrated in FIG. 2, the ink jet printer 1 according to the present embodiment includes a housing 100 and a carriage 110 that is able to reciprocate in the Y-axis direction in the housing 100 and has four head units 3 mounted thereon.

In the present embodiment, as illustrated in FIG. 2, it is assumed that the carriage 110 stores four ink cartridges 120 corresponding to four color inks of cyan, magenta, yellow, and black on a one-to-one basis. In addition, in the present embodiment, as described above, it is assumed that the ink jet printer 1 includes four head units 3 corresponding to the four ink cartridges 120 on a one-to-one basis. Each ejection section D[m] receives the ink supplied from the ink cartridge 120 corresponding to the head unit 3 provided with the ejection section D[m]. Accordingly, each ejection section D[m] can fill the inside with the supplied ink and eject the ink filled inside the ejection section D[m] from the nozzle N provided in the ejection section D[m]. The ink cartridge 120 may be provided outside the carriage 110.

In addition, as described above, the ink jet printer 1 according to the present embodiment includes the transport unit 7. As illustrated in FIG. 2, the transport unit 7 includes a carriage transport mechanism 71 for reciprocating the carriage 110 in the Y-axis direction, a carriage guide shaft 76 that supports the carriage 110 to be reciprocable in the Y-axis direction, a medium transport mechanism 73 for transporting the recording paper PP, and a platen 75 provided in the Z1 direction of the carriage 110. Therefore, when executing the printing process, the transport unit 7 reciprocates the head unit 3 in the Y-axis direction along the carriage guide shaft 76 together with the carriage 110 by the carriage transport mechanism 71 and transports the recording paper PP on the platen 75 in the X1 direction by the medium transport mechanism 73, thereby changing the relative position of the recording paper PP with respect to the head unit 3 is changed, and enabling the ink on the entire recording paper PP.

FIG. 3 is a schematic partial sectional view of the recording head 32 in which the recording head 32 is cut to include the ejection section D[m].

As illustrated in FIG. 3, the ejection section D[m] includes a piezoelectric element PZ[m], a cavity CV filled with ink, a nozzle N that communicates with the cavity CV, and a vibrating plate 321. The ejection section D[m] ejects the ink in the cavity CV from the nozzle N by driving the piezoelectric element PZ[m] by the supply drive signal Vin[m]. The cavity CV is a space defined by a cavity plate 324, a nozzle plate 323 in which the nozzles N are formed, and the vibrating plate 321. The cavity CV communicates with a reservoir 325 via an ink supply port 326. The reservoir 325 communicates with the ink cartridge 120 corresponding to the ejection section D[m] via a common liquid chamber 327. The piezoelectric element PZ[m] includes the upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line Ld set to a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction in accordance with the applied voltage, and as a result, the piezoelectric element PZ[m] vibrates. The lower electrode Zd[m] is joined to the vibrating plate 321. Therefore, when the piezoelectric element PZ[m] is driven by the supply drive signal Vin[m] and vibrates, the vibrating plate 321 also vibrates. The vibration of the vibrating plate 321 changes the volume of the cavity CV and the pressure in the cavity CV, and the ink that fills the cavity CV is ejected from the nozzle N.

In the present embodiment, as an example, it is assumed that flow paths such as the cavities CV provided in each of the M ejection sections D[1] to D[M] included in the head unit 3 communicate with the common liquid chamber 327 that stores the ink. Therefore, in the present embodiment, the vibration generated in one ejection section D among the M ejection sections D[1] to D[M] included in the head unit 3 propagates to another ejection section D via the ink stored in the common liquid chamber 327.

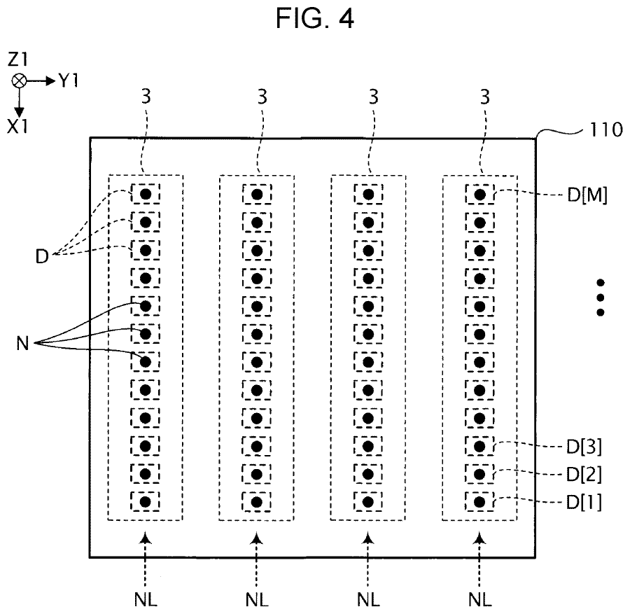

FIG. 4 is an explanatory view for explaining an example of the disposition of the four head units 3 included in the ink jet printer 1 and the total of 4M nozzles N provided in the four head units 3 when the ink jet printer 1 is viewed in a plan view in the Z2 direction. As illustrated in FIG. 4, the head unit 3 is provided with a nozzle line NL. Here, the nozzle line NL is a plurality of nozzles N provided to extend in a line in a predetermined direction.

In the present embodiment, it is assumed as an example that each nozzle line NL is composed of M nozzles N disposed to extend in the X-axis direction. Specifically, in the present embodiment, it is assumed that M nozzles N corresponding to the M ejection sections D[1] to D[M] are disposed side by side in order from the X1 direction to the X2 direction. That is, in the present embodiment, it is assumed that the nozzle N included in the ejection section D[m0] is disposed to be adjacent to the nozzle N included in the ejection section D[m0−1] in the X2 direction included in the ejection section D[m0], and the nozzle N included in the ejection section D[m0+1] is disposed to be adjacent to the nozzle N included in the ejection section D[m0] in the X2 direction included in the ejection section D[m0]. In other words, in the present embodiment, it is assumed that the ejection section D[m0] is disposed to be adjacent to the ejection section D[m0−1] in the X2 direction of the ejection section D[m0−1], and the ejection section D[m0+1] is disposed to be adjacent to the ejection section D[m0] in the X2 direction of the ejection section D[m0]. In this case, the variable m0 is a natural number that satisfies “2≤m0≤M−1”.

### 2. Overview of Head Unit

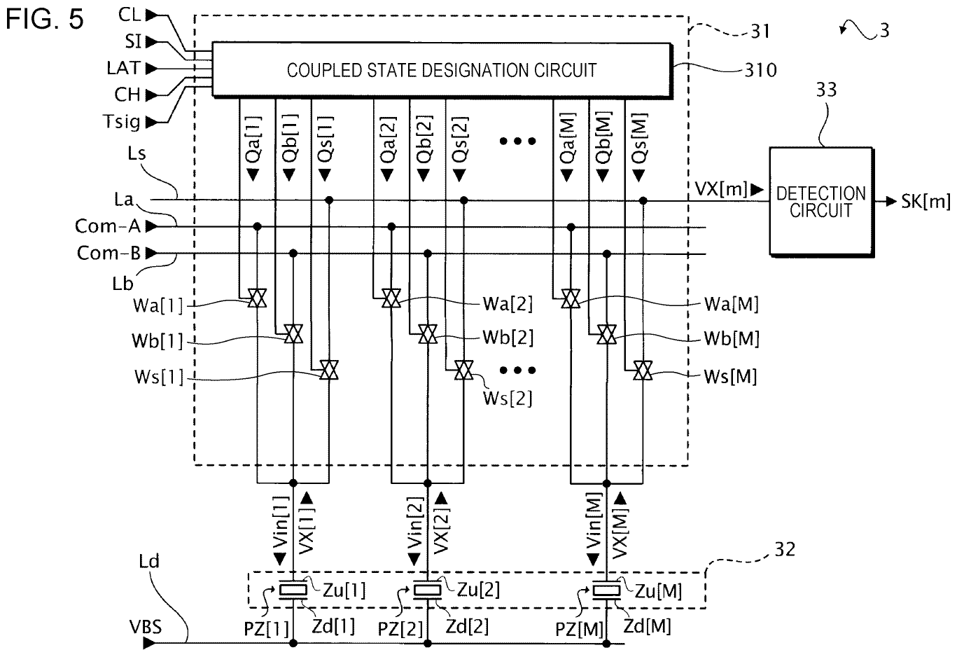

Hereinafter, an overview of the head unit 3 will be described with reference to FIGS. 5 to 7.

FIG. 5 is a block diagram illustrating an example of a configuration of the head unit 3.

As illustrated in FIG. 5, the head unit 3 includes the supply circuit 31, the recording head 32, and the detection circuit 33. In addition, the head unit 3 includes a wiring La through which the drive signal Com-A is supplied from the drive signal generation unit 4, a wiring Lb through which the drive signal Com-B is supplied from the drive signal generation unit 4, a power supply line Ld set to the potential VBS, and a wiring Ls for supplying the detection potential signal VX[m] to the detection circuit 33.

The supply circuit 31 includes M switches Wa[1] to Wa[M] corresponding to the M ejection sections D[1] to D[M] on a one-to-one basis, M switches Wb[1] to Wb[M] corresponding to the M ejection sections D[1] to D[M] on a one-to-one basis, M switches Ws[1] to Ws[M] corresponding to the M ejection sections D[1] to D[M] on a one-to-one basis, and a coupled state designation circuit 310 that designates the coupled state of each switch.

Based on the designation signal SI, a latch signal LAT, a change signal CH, a period designation signal Tsig, and a clock signal CL supplied from the control unit 2, the coupled state designation circuit 310 generates a coupled state designation signal Qa[m] that designates on/off of the switch Wa[m], a coupled state designation signal Qb[m] that designates on/off of the switch Wb[m], and a coupled state designation signal Qs[m] that designates on/off of the switch Ws[m].

The switch Wa[m] switches between conduction and non-conduction between the wiring La and the upper electrode Zu[m] of the piezoelectric element PZ[m] based on the coupled state designation signal Qa[m]. In the present embodiment, the switch Wa[m] is turned on when the coupled state designation signal Qa[m] is at a high level, and is turned off when the coupled state designation signal Qa[m] is at a low level. When the switch Wa[m] is turned on, the drive signal Com-A supplied to the wiring La is supplied to the upper electrode Zu[m] of the ejection section D[m] as the supply drive signal Vin[m]. The switch Wb[m] switches between conduction and non-conduction between the wiring Lb and the upper electrode Zu[m] of the piezoelectric element PZ[m] based on the coupled state designation signal Qb[m]. In the present embodiment, the switch Wb[m] is turned on when the coupled state designation signal Qb[m] is at a high level, and is turned off when the coupled state designation signal Qb[m] is at a low level. When the switch Wb[m] is turned on, the drive signal Com-B supplied to the wiring Lb is supplied to the upper electrode Zu[m] of the ejection section D[m] as the supply drive signal Vin[m]. The switch Ws[m] switches between conduction and non-conduction between the wiring Ls and the upper electrode Zu[m] of the piezoelectric element PZ[m] based on the coupled state designation signal Qs[m]. In the present embodiment, the switch Ws[m] is turned on when the coupled state designation signal Qs[m] is at a high level, and is turned off when the coupled state designation signal Qs[m] is at a low level. When the switch Ws[m] is turned on, the potential of the upper electrode Zu[m] provided in the ejection section D[m] is supplied to the detection circuit 33 via the wiring Ls as the detection potential signal VX[m].

In the present embodiment, the detection circuit 33 generates the detection signal SK[m] having a waveform corresponding to the waveform of the detection potential signal VX[m] based on the detection potential signal VX[m] supplied from the wiring Ls. Specifically, the detection circuit 33 generates a signal that is a signal obtained by amplifying the detection potential signal VX[m] and is obtained by removing the noise component from the detection potential signal VX[m], and outputs the generated signal as the detection signal SK[m].

In the present embodiment, when the ink jet printer 1 executes the printing process, a plurality of unit printing periods TP are set as an operation period of the ink jet printer 1. The ink jet printer 1 can drive each ejection section D for the printing process in each unit printing period TP. In the following, the drive signal Com-A supplied to the head unit 3 in the unit printing period TP may be referred to as a printing drive signal Com-AP, and the drive signal Com-B supplied to the head unit 3 in the unit printing period TP may be referred to as a printing drive signal Com-BP. In addition, in the present embodiment, when the ink jet printer 1 executes the ejection section inspection process, a plurality of unit inspection periods TX or a plurality of unit inspection periods TY are set as the operation period of the ink jet printer 1. In the following, the drive signal Com-A supplied to the head unit 3 in the unit inspection period TX may be referred to as an inspection drive signal Com-AX, and the drive signal Com-B supplied to the head unit 3 in the unit inspection period TX may be referred to as an inspection drive signal Com-BX. In addition, the drive signal Com-A supplied to the head unit 3 in the unit inspection period TY may be referred to as an inspection drive signal Com-AY, and the drive signal Com-B supplied to the head unit 3 in the unit inspection period TY may be referred to as an inspection drive signal Com-BY. In addition, in the following, the unit printing period TP, the unit inspection period TX, and the unit inspection period TY may be collectively referred to as a unit operation period TT.

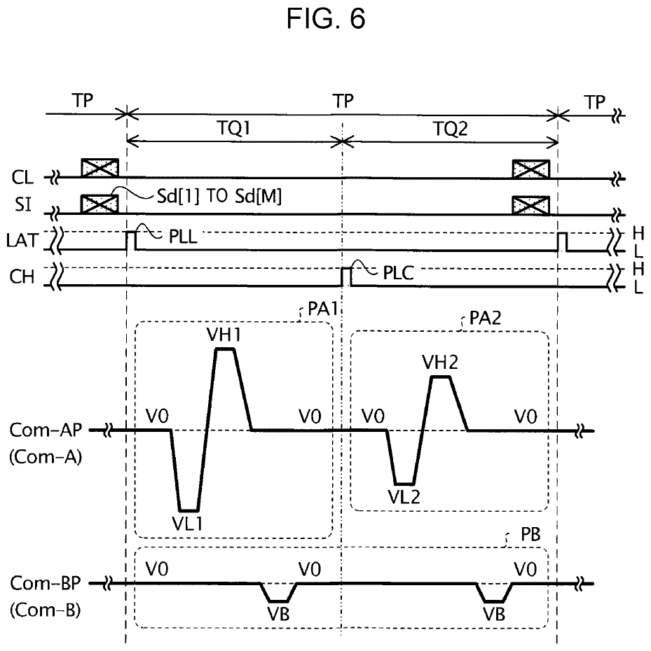

FIG. 6 is a timing chart illustrating an example of various signals, such as the drive signal Com supplied to the head unit 3 in each unit printing period TP.

As illustrated in FIG. 6, when the printing process is executed, the control unit 2 outputs the latch signal LAT having a plurality of pulses PLL. Accordingly, the control unit 2 defines the unit printing period TP as a period from the rise of the pulse PLL to the rise of the next pulse PLL.

In addition, when the printing process is executed, the control unit 2 outputs the change signal CH having the pulse PLC in the unit printing period TP. Accordingly, the control unit 2 divides the unit printing period TP into a control period TQ1 from the rise of the pulse PLL to the rise of the pulse PLC and a control period TQ2 from the rise of the pulse PLC to the rise of the pulse PLL.

As illustrated in FIG. 6, the designation signal SI includes M individual designation signals Sd[1] to Sd[M] corresponding to the M ejection sections D[1] to D[M] on a one-to-one basis. The individual designation signal Sd[m] designates an aspect of the driving of the ejection section D[m] in each unit operation period TT (that is, each unit printing period TP, each unit inspection period TX, or each unit inspection period TY) when the ink jet printer 1 executes the printing process or the ejection section inspection process. When the printing process is executed, the control unit 2 supplies the designation signal SI, including the M individual designation signals Sd[1] to Sd[M], to the coupled state designation circuit 310 in synchronization with the clock signal CL before each unit printing period TP. The coupled state designation circuit 310 generates a coupled state designation signal Qa[m], the coupled state designation signal Qb[m], and the coupled state designation signal Qs[m] based on the individual designation signal Sd[m] in each unit printing period TP.

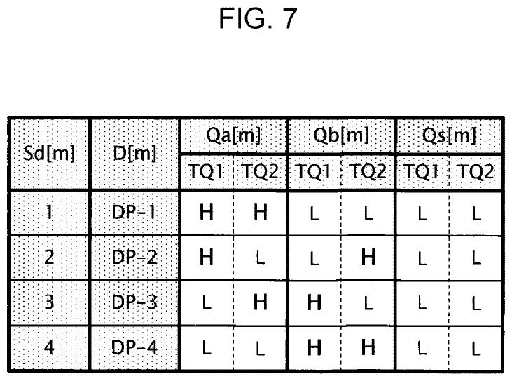

In the present embodiment, the individual designation signal Sd[m] can take any one value among four values, a value “1” for designating the ejection section D[m] as a large dot forming ejection section DP-1, a value “2” for designating the ejection section D[m] as a medium dot forming ejection section DP-2, a value “3” for designating the ejection section D[m] as a small dot forming ejection section DP-3, and a value of “4” for designating the ejection section D[m] as a dot non-forming ejection section DP-4, in the unit printing period TP in which the printing process is executed (refer to FIG. 7 to be described below).

In this case, the large dot forming ejection section DP-1 is an ejection section D that forms a large dot in the unit printing period TP. The medium dot forming ejection section DP-2 is an ejection section D that forms a medium dot in the unit printing period TP. The small dot forming ejection section DP-3 is an ejection section D that forms a small dot in the unit printing period TP. The dot non-forming ejection section DP-4 is an ejection section D that does not form any dot in the unit printing period TP.

As illustrated in FIG. 6, the printing drive signal Com-AP has a waveform PA1 and a waveform PA2 provided for each unit printing period TP. The waveform PA1 is a waveform that is provided in the control period TQ1 of the unit printing period TP and that returns to a reference potential V0 via a potential VL1 lower than the reference potential V0 and a potential VH1 higher than the reference potential V0 from the reference potential V0. When the supply drive signal Vin[m] having the waveform PA1 is supplied to the ejection section D[m], the waveform PA1 is determined such that the ink having an amount equivalent to an ink amount ξ1 is ejected from the ejection section D[m]. The waveform PA2 is a waveform that is provided in the control period TQ2 of the unit printing period TP and that returns to the reference potential V0 via a potential VL2 lower than the reference potential V0 and a potential VH2 higher than the reference potential V0 from the reference potential V0. When the supply drive signal Vin[m] having the waveform PA2 is supplied to the ejection section D[m], the waveform PA2 is determined such that the ink having an amount equivalent to an ink amount ξ2 is ejected from the ejection section D[m]. In the present embodiment, it is assumed that the large dot is formed of the ink having the total amount of the ink amount ξ1 and the ink amount ξ2, the medium dot is formed of the ink having the ink amount ξ1, and the small dot is formed of the ink having the ink amount ξ2.

In the present embodiment, as an example, it is assumed that, when the potential of the supply drive signal Vin[m] supplied to the ejection section D[m] is high, the volume of the cavity CV provided in the ejection section D[m] decreases as compared with the case of the low potential. Therefore, when the ejection section D [m] is driven by the supply drive signal Vin[m] having the waveform PA1 or the waveform PA2, the potential of the supply drive signal Vin[m] changes from a low potential to a high potential, so that the ink in the ejection section D [m] is ejected from the nozzle N.

As illustrated in FIG. 6, the printing drive signal Com-BP has a waveform PB provided for each unit printing period TP. Here, the waveform PB is a waveform including two micro-vibration waveforms, a micro-vibration waveform that is provided in the control period TQ1 of each unit printing period TP and returns to the reference potential V0 via a potential VB lower than the reference potential V0 from the reference potential V0, and a micro-vibration waveform that is provided in the control period TQ2 of each unit printing period TP and returns to the reference potential V0 via the potential VB lower than the reference potential V0 from the reference potential V0. In the present embodiment, the waveform PB is provided such that the ink is not ejected from the ejection section D[m] even when the ejection section D[m] is driven by the printing drive signal Com-BP.

FIG. 7 is an explanatory view illustrating an example of the operation of the coupled state designation circuit 310 in the unit printing period TP.

As illustrated in FIG. 7, when the individual designation signal Sd[m] indicates the value “1” for designating the ejection section D[m] as the large dot forming ejection section DP-1 in the unit printing period TP, the coupled state designation circuit 310 maintains the coupled state designation signal Qa[m] at a high level throughout the unit printing period TP. In this case, the switch Wa[m] is turned on throughout the unit printing period TP. Therefore, the ejection section D[m] is driven by the supply drive signal Vin[m] having the waveform PA1 and the waveform PA2 in the unit printing period TP, and ejects the ink having the total amount of the ink amount ξ1 and the ink amount ξ2, which is an amount equivalent to the large dot. In addition, when the individual designation signal Sd[m] indicates the value “2” for designating the ejection section D[m] as the medium dot forming ejection section DP-2 in the unit printing period TP, the coupled state designation circuit 310 maintains the coupled state designation signal Qa[m] at a high level in the control period TQ1 and maintains the coupled state designation signal Qb[m] at a high level in the control period TQ2. In this case, the switch Wa[m] is turned on in the control period TQ1, and the switch Wb[m] is turned on in the control period TQ2. Therefore, the ejection section D[m] is driven by the supply drive signal Vin[m] having the waveform PA1 in the control period TQ1, and ejects the ink having the ink amount ξ1, which is an amount equivalent to the medium dot. In addition, when the individual designation signal Sd[m] indicates the value “3” for designating the ejection section D[m] as the small dot forming ejection section DP-3 in the unit printing period TP, the coupled state designation circuit 310 maintains the coupled state designation signal Qb[m] at a high level in the control period TQ1 and maintains the coupled state designation signal Qa[m] at a high level in the control period TQ2. In this case, the switch Wa[m] is turned on in the control period TQ2. Therefore, the ejection section D[m] is driven by the supply drive signal Vin[m] having the waveform PA2 in the control period TQ2, and ejects the ink having the ink amount ξ2, which is an amount equivalent to the small dot. In addition, when the individual designation signal Sd[m] indicates the value “4” for designating the ejection section D[m] as the dot non-forming ejection section DP-4 in the unit printing period TP, the coupled state designation circuit 310 maintains the coupled state designation signal Qb[m] at a high level throughout the unit printing period TP. In this case, the switch Wb[m] is turned on throughout the unit printing period TP. Therefore, the ejection section D[m] is driven not to eject the ink by the supply drive signal Vin[m] having a micro-vibration waveform in the unit printing period TP.

### 3. Overview of Ejection Section Inspection Process

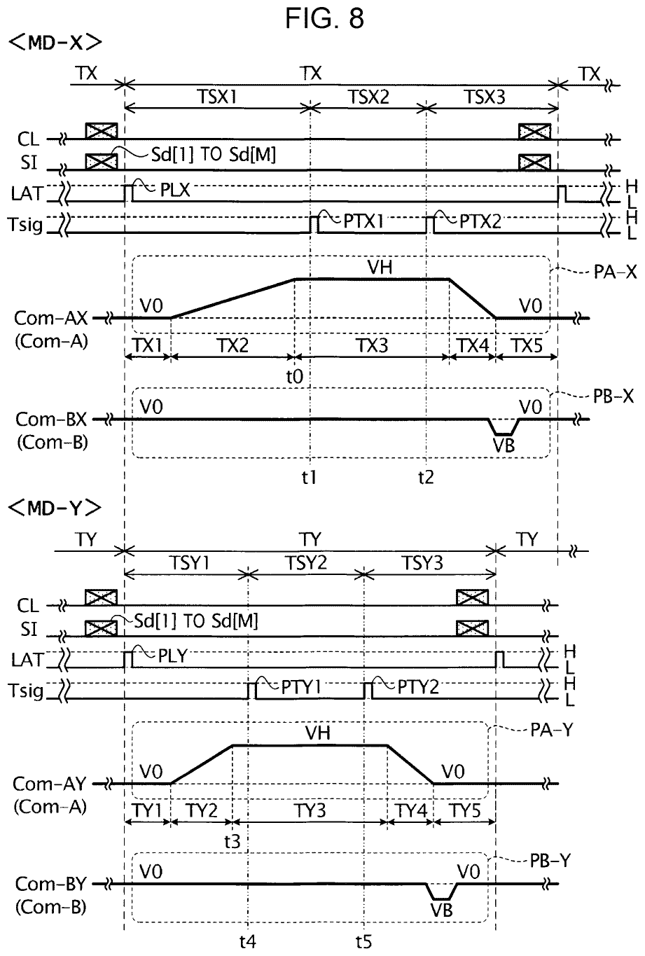

Hereinafter, an overview of the ejection section inspection process will be described with reference to FIGS. 8 to 18.

### 3.1. Inspection Mode Md

In the present embodiment, as an example, it is assumed that the ink jet printer 1 can execute the ejection section inspection process by two inspection modes MD, including a normal inspection mode MD-X and a high-speed inspection mode MD-Y.

Here, the normal inspection mode MD-X is an inspection mode MD in which the state of the inspection target ejection section DK is inspected in a state in which the cavities CV of the inspection target ejection section DK and the drive target ejection section DD are filled with ink. Specifically, the normal inspection mode MD-X is an inspection mode MD in which the state of the inspection target ejection section DK is inspected in a state in which the ink is filled in each of the cavities CV of the ejection sections D[1] to D[M]. For example, the normal inspection mode MD-X may be the inspection mode MD used in the ejection section inspection process performed in a state in which by a user of the ink jet printer 1 has mounted the ink cartridge 120 on the ink jet printer 1 and has supplied the ink from the ink cartridge 120 to the cavity CV, after the product shipment of the ink jet printer 1.

In addition, the high-speed inspection mode MD-Y is an inspection mode MD in which the state of the inspection target ejection section DK is inspected in a state in which the cavities CV of the inspection target ejection section DK and the drive target ejection section DD are not filled with ink. Specifically, the high-speed inspection mode MD-Y is an inspection mode MD in which the state of the inspection target ejection section DK is inspected in a state in which the ink is not filled in the cavity CV of each of the ejection sections D[1] to D[M]. For example, the high-speed inspection mode MD-Y may be an inspection mode MD used in the ejection section inspection process performed in a state in which the ink is not filled in the cavity CV of each of the ejection sections D[1] to D[M] before the product shipment of the ink jet printer 1.

In the present embodiment, it is assumed that the high-speed inspection mode MD-Y is an inspection mode MD used in the ejection section inspection process in a state in which the cavities CV of the inspection target ejection section DK and the drive target ejection section DD are not filled with ink. However, the present disclosure is not limited to such an aspect. The high-speed inspection mode MD-Y may be an inspection mode MD used in the ejection section inspection process in a state in which the cavities CV of the inspection target ejection section DK and the drive target ejection section DD are filled with a specific type of liquid. Here, the specific type of liquid is a liquid having a lower viscosity than the liquid filling the cavities CV of the inspection target ejection section DK and the drive target ejection section DD in the normal inspection mode MD-X. Specifically, the specific type of liquid may be, for example, a liquid that is not used for forming an image in the printing process executed by the ink jet printer 1. More specifically, the specific type of liquid may be, for example, a preservative liquid for protecting the ejection section D included in the ink jet printer 1 before the shipment of the ink jet printer 1, a freezing liquid for preventing the freezing of the ejection section D included in the ink jet printer 1 before the shipment of the ink jet printer 1, or a cleaning liquid for cleaning a flow path communicating with the ejection section D included in the ink jet printer 1.

In the present embodiment, the control unit 2 selects the inspection mode MD when the ejection section inspection process is executed, based on the presence/absence of mounting of the ink cartridge 120 on the carriage 110 and the type of the ink cartridge 120 mounted on the carriage 110. However, the present disclosure is not limited to such an aspect. The control unit 2 may select the inspection mode MD when the ejection section inspection process is executed based on the operation of the ink jet printer 1 by a user or the operation of the ink jet printer 1 by a setting operator.

### 3.2. Various Signals Related to Ejection Section Inspection Process

FIG. 8 is a timing chart illustrating an example of various signals, such as the drive signal Com supplied to the head unit 3 in the unit inspection period TX and the unit inspection period TY.

As illustrated in FIG. 8, when the ejection section inspection process in the normal inspection mode MD-X is executed, the control unit 2 outputs the latch signal LAT having a plurality of pulses PLX. Accordingly, the control unit 2 defines the unit inspection period TX as a period from the rise of the pulse PLX to the rise of the next pulse PLX. In addition, when the ejection section inspection process in the high-speed inspection mode MD-Y is executed, the control unit 2 outputs the latch signal LAT having a plurality of pulses PLY. Accordingly, the control unit 2 defines the unit inspection period TY, which is a period shorter than the unit inspection period TX, as a period from the rise of the pulse PLY to the rise of the next pulse PLY. In the following, the unit inspection period TX and the unit inspection period TY may be collectively referred to as a unit inspection period TXY.

As illustrated in FIG. 8, when the ejection section inspection process in the normal inspection mode MD-X is executed, the control unit 2 outputs the period designation signal Tsig having a pulse PTX1 and a pulse PTX2. Accordingly, the control unit 2 divides the unit inspection period TX into a control period TSX1 from the rise of the pulse PLX to the rise of the pulse PTX1, a control period TSX2 from the rise of the pulse PTX1 to the rise of the pulse PTX2, and a control period TSX3 from the rise of the pulse PTX2 to the rise of the pulse PLX. In addition, when the ejection section inspection process in the high-speed inspection mode MD-Y is executed, the control unit 2 outputs the period designation signal Tsig having a pulse PTY1 and a pulse PTY2. Accordingly, the control unit 2 divides the unit inspection period TY into a control period TSY1 from the rise of the pulse PLY to the rise of the pulse PTY1, a control period TSY2 from the rise of the pulse PTY1 to the rise of the pulse PTY2, and the control period TSY3 from the rise of the pulse PTY2 to the rise of the pulse PLY.

In the present embodiment, as an example, it is assumed that the control period TSX1 has a time length longer than the time length of the control period TSY1, the control period TSX2 and the control period TSY2 have the same time length, and the control period TSX3 and the control period TSY3 have the same time length. In the following, the control period TSX1 and the control period TSY1 may be collectively referred to as a control period TS1, the control period TSX2 and the control period TSY2 may be collectively referred to as a control period TS2, and the control period TSX3 and the control period TSY3 may be collectively referred to as a control period TS3.

As illustrated in FIG. 8, when the ejection section inspection process in the normal inspection mode MD-X is executed, the control unit 2 controls the drive signal generation unit 4 such that the inspection drive signal Com-AX is supplied as the drive signal Com-A and the inspection drive signal Com-BX is supplied as the drive signal Com-B. In addition, when the ejection section inspection process in the high-speed inspection mode MD-Y is executed, the control unit 2 controls the drive signal generation unit 4 such that the inspection drive signal Com-AY is supplied as the drive signal Com-A and the inspection drive signal Com-BY is supplied as the drive signal Com-B.

As illustrated in FIG. 8, the inspection drive signal Com-AX has a waveform PA-X provided in the unit inspection period TX. Here, the waveform PA-X is a waveform that maintains the reference potential V0 in a control period TX1 of the unit inspection period TX, changes in potential from the reference potential V0 to a drive potential VH in a control period TX2, following the control period TX1 of the unit inspection period TX, maintains the drive potential VH in a control period TX3, following the control period TX2, of the unit inspection period TX, changes in potential from the drive potential VH to the reference potential V0 in a control period TX4, following the control period TX3, of the unit inspection period TX, and maintains the reference potential V0 in a control period TX5, following the control period TX4, of the unit inspection period TX. Among these, the control period TX1 is included in the control period TSX1, starts at the same time as the start of the control period TSX1, and ends before the end of the control period TSX1. The control period TX2 is included in the control period TSX1, starts after the start of the control period TSX1, and ends before the end of the control period TSX1. The control period TX3 includes part of the control period TSX1, the entire control period TSX2, and part of the control period TSX3, starts after the start of the control period TSX1 and before the start of the control period TSX2, and ends after the end of the control period TSX2 and before the end of the control period TSX3. That is, the control period TSX2 is included in the control period TX3. The control period TX4 is included in the control period TSX3, starts after the start of the control period TSX3, and ends before the end of the control period TSX3. The control period TX5 is included in the control period TSX3, starts after the start of the control period TSX3, and ends at the same time as the end of the control period TSX3. In the present embodiment, the time length of the control period TX2 is longer than the time length of the control period TX4.

In addition, in the present embodiment, it is assumed that the drive potential VH is a potential higher than the reference potential V0, but the present disclosure is not limited to such an aspect. The drive potential VH may be a lower potential than the reference potential V0. In addition, in the present embodiment, it is assumed that the waveform PA-X maintains the reference potential V0 in the control period TX1, but the present disclosure is not limited to such an aspect. The waveform PA-X may be at least a waveform in which the potentials at the start and end of the control period TX1 are the reference potential V0. In addition, in the present embodiment, it is assumed that the waveform PA-X maintains the reference potential V0 in the control period TX5, but the present disclosure is not limited to such an aspect. The waveform PA-X may be at least a waveform in which the potentials at the start and end of the control period TX5 are the reference potential V0.

In addition, the inspection drive signal Com-BX has a waveform PB-X provided in the unit inspection period TX. Here, in the waveform PB-X, the reference potential V0 is maintained in the control period TSX1 and the control period TSX2 of the unit inspection period TX, and a micro-vibration waveform is provided in the control period TSX3 of the unit inspection period TX. As described above, the micro-vibration waveform is a waveform that returns to the reference potential V0 via the potential VB having a potential lower than the reference potential V0 from the reference potential V0.

As illustrated in FIG. 8, the inspection drive signal Com-AY has a waveform PA-Y provided in the unit inspection period TY. Here, the waveform PA-Y is a waveform that maintains the reference potential V0 in a control period TY1 of the unit inspection period TY, changes in potential from the reference potential V0 to the drive potential VH in a control period TY2, following the control period TY1, of the unit inspection period TY, maintains the drive potential VH in a control period TY3, following the control period TY2, of the unit inspection period TY, changes in potential from the drive potential VH to the reference potential V0 in a control period TY4, following the control period TY3, of the unit inspection period TY, and maintains the reference potential V0 in a control period TY5, following the control period TY4, of the unit inspection period TY. Among these, the control period TY1 is included in the control period TSY1, starts at the same time as the start of the control period TSY1, and ends before the end of the control period TSY1. The control period TY2 is included in the control period TSY1, starts after the start of the control period TSY1, and ends before the end of the control period TSY1. The control period TY3 includes part of the control period TSY1, the entire control period TSY2, and part of the control period TSY3, starts after the start of the control period TSY1 and before the start of the control period TSY2, and ends after the end of the control period TSY2 and before the end of the control period TSY3. That is, the control period TSY2 is included in the control period TY3. The control period TY4 is included in the control period TSY3, starts after the start of the control period TSY3, and ends before the end of the control period TSY3. The control period TY5 is included in the control period TSY3, starts after the start of the control period TSY3, and ends at the same time as the end of the control period TSY3. In the present embodiment, the time length of the control period TY2 is shorter than the time length of the control period TX2. In addition, in the present embodiment, the time length of the control period TY2 is equal to or less than the time length of the control period TY4. However, the present disclosure is not limited to such an aspect. The time length of the control period TY2 may be longer than the time length of the control period TY4.

In addition, in the present embodiment, it is assumed that the waveform PA-Y maintains the reference potential V0 in the control period TY1, but the present disclosure is not limited to such an aspect. The waveforms PA-Y may be at least a waveform in which the potentials at the start and end of the control period TY1 are the reference potential V0. In addition, in the present embodiment, it is assumed that the waveform PA-Y maintains the reference potential V0 in the control period TY5, but the present disclosure is not limited to such an aspect. The waveforms PA-Y may be at least a waveform in which the potentials at the start and end of the control period TY5 are the reference potential V0.

In addition, the inspection drive signal Com-BY has a waveform PB-Y provided in the unit inspection period TY. Here, in the waveform PB-Y, the reference potential V0 is maintained in the control period TSY1 and the control period TSY2 of the unit inspection period TY, and a micro-vibration waveform is provided in the control period TSY3 of the unit inspection period TY. As described above, the micro-vibration waveform is a waveform that returns to the reference potential V0 via the potential VB having a potential lower than the reference potential V0 from the reference potential V0.

In the present embodiment, it is assumed that the time length of the unit inspection period TX is longer than the time length of the unit printing period TP, and the time length of the unit inspection period TY is equal to the time length of the unit printing period TP. However, the present disclosure is not limited to such an aspect. For example, the time length of the unit inspection period TX may be the same as the time length of the unit printing period TP. In addition, the time length of the unit inspection period TY may be shorter than the time length of the unit printing period TP, or may be longer than the time length of the unit printing period TP. The time length of the unit inspection period TX may be equal to or longer than the time length of the unit inspection period TY.

In the following, the inspection drive signal Com-AX and the inspection drive signal Com-AY may be collectively referred to as an inspection drive signal Com-AXY, and the inspection drive signal Com-BX and the inspection drive signal Com-BY may be collectively referred to as an inspection drive signal Com-BXY. In addition, in the following, the waveform PA-X and the waveform PA-Y may be collectively referred to as a waveform PA-XY, and the waveform PB-X and the waveform PB-Y may be collectively referred to as a waveform PB-XY.

As illustrated in FIG. 8, when the ejection section inspection process is executed, the control unit 2 supplies the designation signal SI including the M individual designation signals Sd[1] to Sd[M] to the coupled state designation circuit 310 in synchronization with the clock signal CL before each unit inspection period TXY (unit inspection period TX or unit inspection period TY). The coupled state designation circuit 310 generates the coupled state designation signal Qa[m], the coupled state designation signal Qb[m], and the coupled state designation signal Qs[m] based on the individual designation signal Sd[m] in each unit inspection period TXY.

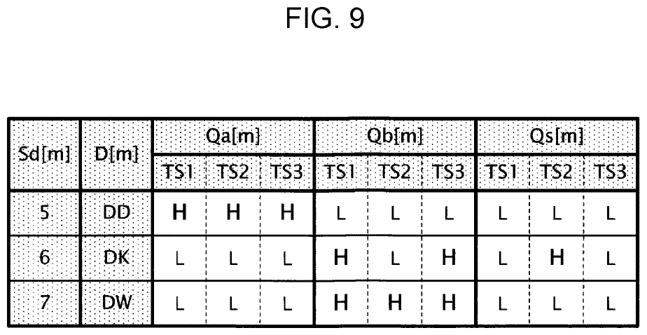

FIG. 9 is an explanatory view illustrating an example of the operation of the coupled state designation circuit 310 in the unit inspection period TXY (unit inspection period TX or unit inspection period TY).

As illustrated in FIG. 9, the individual designation signal Sd[m] can take any one value among three values, that is, a value “5” for designating the ejection section D[m] as the drive target ejection section DD, a value “6” for designating the ejection section D[m] as the inspection target ejection section DK, and a value “7” for designating the ejection section D[m] as a standby ejection section DW, in the unit inspection period TXY (unit inspection period TX or unit inspection period TY) during which the ejection section inspection process is executed.

Here, the drive target ejection section DD is an ejection section D that is a target to be driven in the ejection section inspection process as described above. The inspection target ejection section DK is an ejection section D that is a target to be inspected in the ejection section inspection process as described above. As described above, in the present embodiment, it is assumed that the inspection target ejection section DK and the drive target ejection section DD are adjacent to each other. In addition, the standby ejection section DW is an ejection section D other than the inspection target ejection section DK and the drive target ejection section DD, among the M ejection sections D[1] to D[M] included in the head unit 3.

As illustrated in FIG. 9, when the individual designation signal Sd[m] indicates the value “5” for designating the ejection section D[m] as the drive target ejection section DD in the unit inspection period TXY, the coupled state designation circuit 310 maintains the coupled state designation signal Qa[m] at a high level throughout the unit inspection period TXY. In this case, the switch Wa[m] is turned on throughout the unit inspection period TXY. Therefore, the ejection section D[m] is driven by the supply drive signal Vin[m] having the waveform PA-X or the waveform PA-Y in the unit inspection period TXY, and the potential in the control period TS2 (control period TSX2 or control period TSY2) is set to the drive potential VH. In addition, when the individual designation signal Sd[m] indicates the value “7” for designating the ejection section D[m] as the standby ejection section DW in the unit inspection period TXY, the coupled state designation circuit 310 maintains the coupled state designation signal Qb[m] at a high level throughout the unit inspection period TXY. In this case, the switch Wb[m] is turned on throughout the unit inspection period TXY. Therefore, the ejection section D[m] is driven by the supply drive signal Vin[m] having the waveform PB-X or the waveform PB-Y in the unit inspection period TXY, and the potential in the control period TS2 (control period TSX2 or control period TSY2) is set to the reference potential V0.

As illustrated in FIG. 9, when the individual designation signal Sd[m] indicates the value “6” for designating the ejection section D[m] as the inspection target ejection section DK in the unit inspection period TXY, the coupled state designation circuit 310 maintains the coupled state designation signal Qb[m] at a high level in the control period TS1 and the control period TS3, and maintains the coupled state designation signal Qs[m] at a high level in the control period TS2. In this case, the switch Wb[m] is turned on in the control period TS1 and the control period TS3, and the switch Ws[m] is turned on in the control period TS2. Then, the detection circuit 33 detects the potential of the upper electrode Zu[m] included in the ejection section D[m] as the detection potential signal VX[m] via the switch Ws[m] in the control period TS2 (control period TSX2 or control period TSY2).

In the present embodiment, it is assumed that, in each unit inspection period TXY, one ejection section D[m] among the M ejection sections D[1] to D[M] is designated as the inspection target ejection section DK, one ejection section D is designated as the drive target ejection section DD, and the remaining (M-2) ejection sections D are designated as the standby ejection sections DW. However, the present disclosure is not limited to such an aspect. In each unit inspection period TXY, one ejection section D[m] among the M ejection sections D[1] to D[M] may be designated as the inspection target ejection section DK, some or all of the remaining (M-1) ejection sections D may be designated as the drive target ejection sections DD, and the ejection section D that is not designated as the inspection target ejection section DK or the drive target ejection sections DD may be designated as the standby ejection section DW.

### 3.3. Operation of Head Unit 3 in Ejection Section Inspection Process

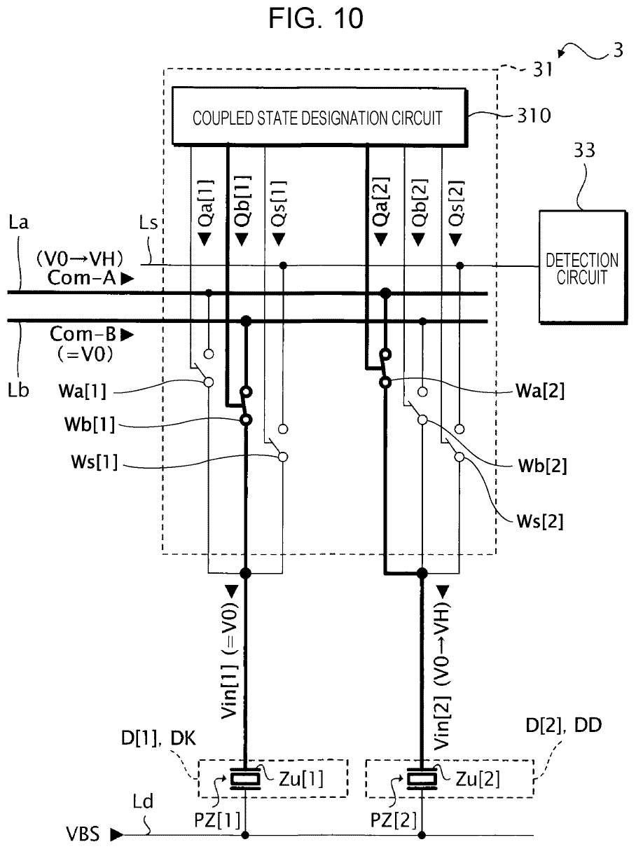

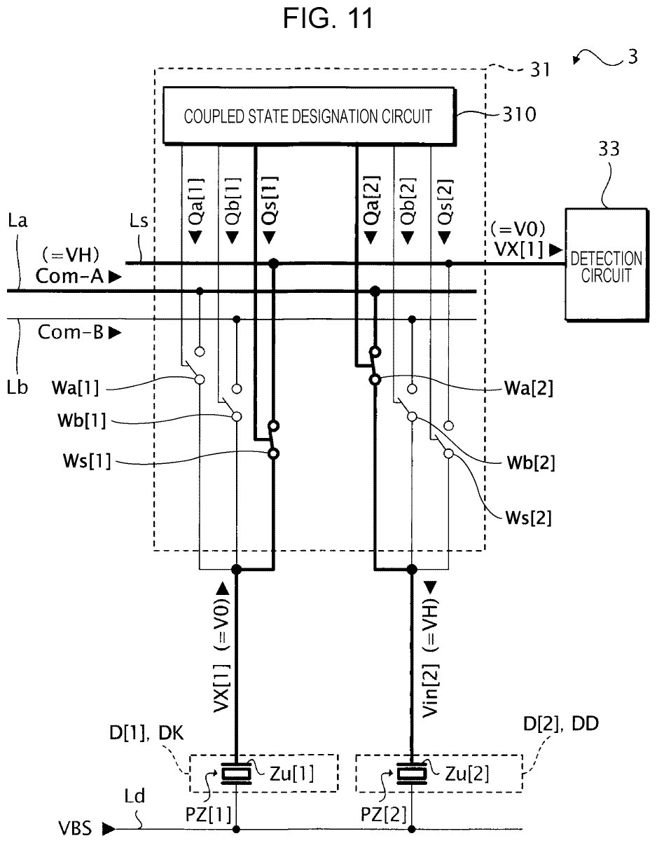

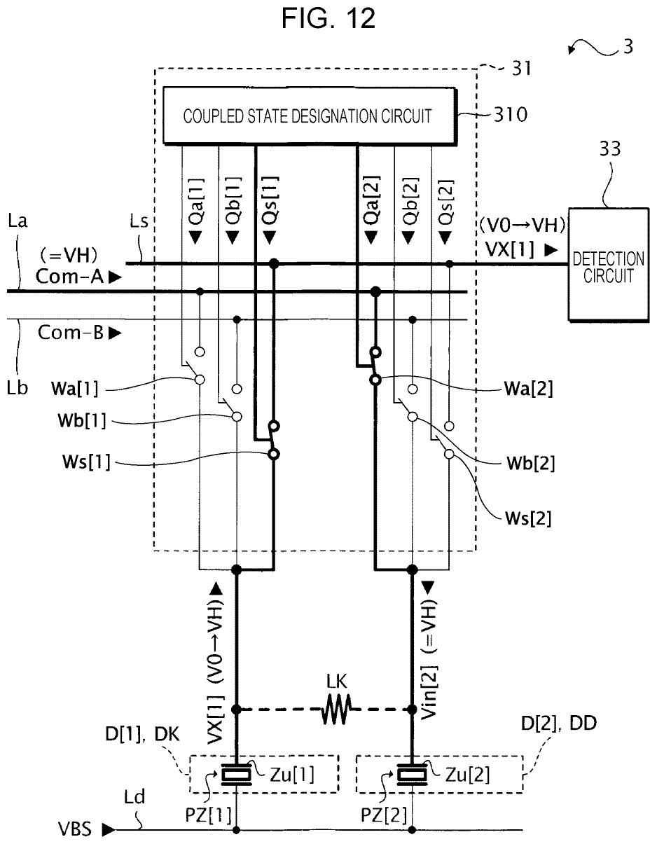

FIGS. 10 to 12 are explanatory views illustrating examples of the operation of the head unit 3. In the examples illustrated in FIGS. 10 to 12, for convenience of description, two ejection sections D, including the ejection section D[1] and the ejection section D[2], among the M ejection sections D[1] to D[M] included in the head unit 3 are illustrated. In addition, in the examples illustrated in FIGS. 10 to 12, a case where the ejection section D[1] is designated as the inspection target ejection section DK and the ejection section D[2] is designated as the drive target ejection section DD is exemplified. In the example illustrated in FIG. 10, an example of the operation of the head unit 3 in the control period TS1 of the unit inspection period TXY is illustrated. In addition, the example illustrated in FIG. 11 is an example of the operation of the head unit 3 in the control period TS2 following the control period TS1 illustrated in FIG. 10, and illustrates a case where each of the M ejection sections D[1] to D[M] included in the head unit 3 has a predetermined power storage capacity. In addition, the example illustrated in FIG. 12 is an example of the operation of the head unit 3 in the control period TS2 following the control period TS1 illustrated in FIG. 10, and illustrates a case where a short-circuit path LK is formed between the ejection section D[1] and the ejection section D[2] among the M ejection sections D[1] to D[M] included in the head unit 3, and the ejection section D[1] and the ejection section D[2] do not have a predetermined power storage capacity.

As illustrated in FIG. 10, in the unit inspection period TXY, when the ejection section D[1] is designated as the inspection target ejection section DK and the ejection section D[2] is designated as the drive target ejection section DD, in the control period TS1 of the unit inspection period TXY, the upper electrode Zu[1] included in the ejection section D[1] and the wiring Lb are electrically coupled to each other via the switch Wb[1], and the upper electrode Zu[2] included in the ejection section D[2] and the wiring La are electrically coupled to each other via the switch Wa[2]. Therefore, in the control period TS1, the potential of the upper electrode Zu[1] is set to the reference potential V0, which is the potential of the inspection drive signal Com-BXY (inspection drive signal Com-BX or inspection drive signal Com-BY) in the control period TS1. In addition, in the control period TS1, the potential of the upper electrode Zu[2] changes from the reference potential V0 to the drive potential VH, similar to the potential change of the inspection drive signal Com-AXY (inspection drive signal Com-AX or inspection drive signal Com-AY) in the control period TS1.

As illustrated in FIG. 11, when the ejection section D[1] and the ejection section D[2] have a predetermined power storage capacity, in the control period TS2 following the control period TS1 illustrated in FIG. 10, the upper electrode Zu[1] included in the ejection section D[1] and the wiring Ls are electrically coupled to each other via the switch Ws[1], and the upper electrode Zu[2] included in the ejection section D[2] and the wiring La are electrically coupled to each other via the switch Wa[2]. Therefore, in the control period TS2, the potential of the upper electrode Zu[2] is set to the drive potential VH, which is the potential of the inspection drive signal Com-AXY in the control period TS2. In addition, in the control period TS2, the potential of the upper electrode Zu[1] maintains the reference potential V0, which is the potential set in the control period TS1, and a detection potential signal VX[1] indicating the reference potential V0 is supplied to the detection circuit 33 via the wiring Ls.

As illustrated in FIG. 12, when the short-circuit path LK is formed between the upper electrode Zu[1] and the upper electrode Zu[2], at the start point of the control period TS2 following the control period TS1 illustrated in FIG. 10, the potential of the upper electrode Zu[1] is set to the reference potential V0, and the potential of the upper electrode Zu[2] is set to the drive potential VH. However, in the control period TS2, the potential of the upper electrode Zu[1] changes to approach the potential of the upper electrode Zu[2] as a result of the leak current flowing through the short-circuit path LK. That is, in the control period TS2, the potential of the upper electrode Zu[1] changes from the reference potential V0 to approach the drive potential VH. Therefore, in the control period TS2, the detection circuit 33 detects the detection potential signal VX[1] in which the potential changes to approach the drive potential VH from the reference potential V0.

### 3.4. Detection Potential Signal VX[m] in Ejection Section Inspection Process

In the present embodiment, the inspection unit 5 determines whether or not the potential change amount of the detection potential signal VX[m] in the control period TS2 is equal to or greater than a threshold dVth by using the detection signal SK[m] generated by the detection circuit 33 based on the detection potential signal VX[m]. Specifically, the inspection unit 5 determines whether or not the detection potential signal VX[m] is a potential equal to or higher than the threshold potential Vth in the control period TS2 based on the detection signal SK[m]. Here, the threshold potential Vth is a potential obtained by adding the threshold dVth to the reference potential V0. Then, when the result of the determination is negative, that is, when the potential change amount of the detection potential signal VX[m] in the control period TS2 is less than the threshold dVth, the inspection result signal SS[m] indicating a value (for example, “1”) according to a determination result that the ejection section D[m] has a predetermined power storage capacity is output. On the other hand, when the result of the determination is positive, that is, when the potential change amount of the detection potential signal VX[m] in the control period TS2 is equal to or greater than the threshold dVth, the inspection result signal SS[m] indicating a value (for example, “0”) according to the determination result that the ejection section D[m] does not have a predetermined power storage capacity is output.

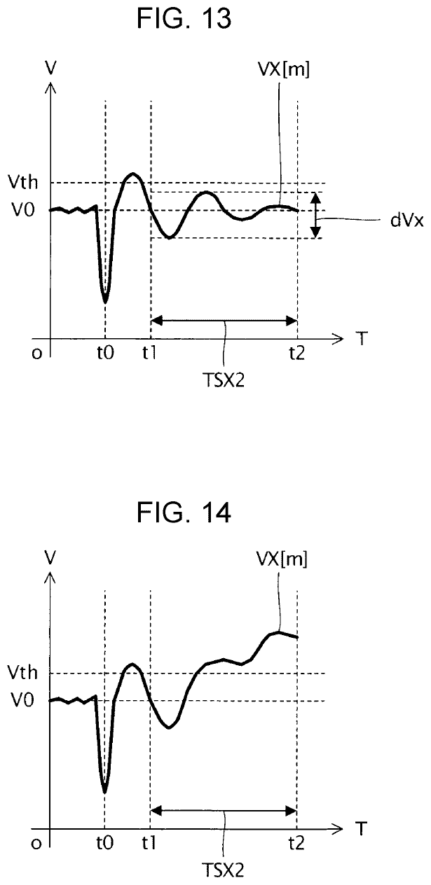

FIG. 13 is a view illustrating a change in potential of the upper electrode Zu[m] when the ejection section inspection process is executed in the normal inspection mode MD-X. In the figure, it is assumed that the ejection section D[m] designated as the inspection target ejection section DK has a predetermined power storage capacity.

As described above, the inspection drive signal Com-AX changes in potential from the reference potential V0 to the drive potential VH in the control period TX2, and maintains the drive potential VH in the control period TX3. That is, the change in potential of the inspection drive signal Com-AX is stopped at the time t0 when the control period TX2 ends. Therefore, the drive target ejection section DD vibrates at time t0. Then, the vibration generated in the drive target ejection section DD at time t0 propagates to the ejection section D[m] designated as the inspection target ejection section DK. Then, when the ejection section D[m] vibrates, the piezoelectric element PZ[m] is displaced in response to the vibration. Therefore, as illustrated in FIG. 13, the potential of the detection potential signal VX[m] fluctuates at time t0. Thereafter, the vibration remaining in the ejection section D[m] attenuates, and the amplitude of the detection potential signal VX[m] also attenuates.

In the present embodiment, the inspection unit 5 inspects the state of the ejection section D[m] based on the potential of the detection potential signal VX[m] in the control period TSX2. Specifically, the inspection unit 5 inspects the state of the ejection section D[m] by inspecting whether or not the potential of the detection potential signal VX[m] is equal to or higher than the threshold potential Vth in the control period TSX2. In the present embodiment, in the ejection section inspection process in the normal inspection mode MD-X, when the ejection section D[m] designated as the inspection target ejection section DK has a predetermined power storage capacity, it is assumed that the inclination of the waveform PA-X in the control period TX2 is set such that an amplitude dVx of the detection potential signal VX[m] is less than the threshold dVth and at the time t1 when the control period TSX2 starts. That is, in the present embodiment, in the ejection section inspection process in the normal inspection mode MD-X, when the ejection section D[m] designated as the inspection target ejection section DK has a predetermined power storage capacity, it is assumed that the waveform PA-X is set such that the detection potential signal VX[m] is not equal to or greater than the threshold potential Vth from the time t1 when the control period TSX2 starts to the time t2 when the control period TSX2 ends.

FIG. 14 is a diagram illustrating a change in potential of the upper electrode Zu[m] when the ejection section inspection process in the normal inspection mode MD-X is executed. In the figure, it is assumed that the ejection section D[m] designated as the inspection target ejection section DK does not have a predetermined power storage capacity.

As described above, in the ejection section inspection process, when the ejection section D[m] designated as the inspection target ejection section DK does not have a predetermined power storage capacity, the potential of the upper electrode Zu[m] in the control period TSX2 changes to approach the drive potential VH from the reference potential V0. Therefore, in the ejection section inspection process in the normal inspection mode MD-X, when the ejection section D[m] designated as the inspection target ejection section DK does not have a predetermined power storage capacity, as illustrated in FIG. 14, the potential of the detection potential signal VX[m] changes such that vibration occurs with the amplitude dVx smaller than the threshold dVth in the control period TSX2 and the center of the amplitude approaches the drive potential VH from the reference potential V0. In the present embodiment, in the ejection section inspection process in the normal inspection mode MD-X, when the ejection section D[m] designated as the inspection target ejection section DK does not have a predetermined power storage capacity, it is assumed that the drive potential VH included in the waveform PA-X is set such that the detection potential signal VX[m] is equal to or higher than the threshold potential Vth from the time t1 when the control period TSX2 starts to the time t2 when the control period TSX2 ends. Thus, in the present embodiment, in the normal inspection mode MD-X, the inspection unit 5 can inspect the state of the ejection section D[m] by inspecting whether or not the potential of the detection potential signal VX[m] in the control period TSX2 is equal to or higher than the threshold potential Vth.

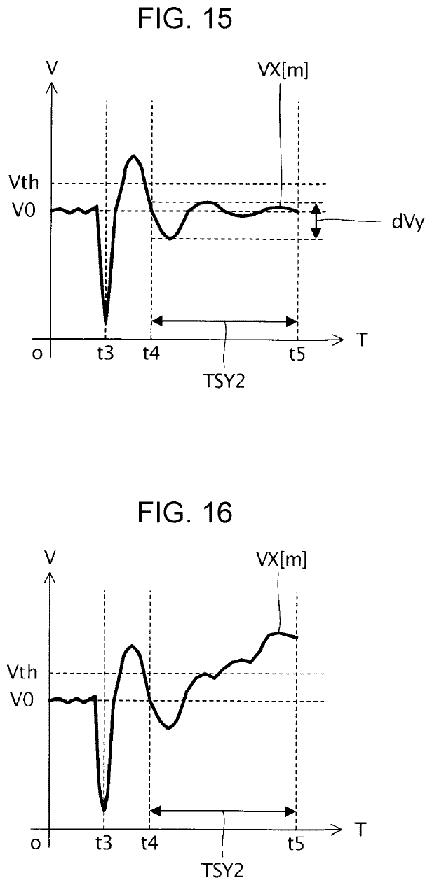

FIG. 15 is a view illustrating a change in potential of the upper electrode Zu[m] when the ejection section inspection process in the high-speed inspection mode MD-Y is executed. In the figure, it is assumed that the ejection section D[m] designated as the inspection target ejection section DK has a predetermined power storage capacity.

As described above, the inspection drive signal Com-AY changes in potential from the reference potential V0 to the drive potential VH in the control period TY2, and maintains the drive potential VH in the control period TY3. The control period TY2 is shorter than the control period TX2. That is, the inclination of the waveform PA-Y included in the inspection drive signal Com-AY in the control period TY2 is steeper than the inclination of the waveform PA-X included in the inspection drive signal Com-AX in the control period TX2. Therefore, the amplitude of the vibration generated in the drive target ejection section DD at the time t3 when the control period TY2 ends when the ejection section inspection process is performed by the high-speed inspection mode MD-Y is larger than the amplitude of the vibration generated in the drive target ejection section DD at the time t0 when the control period TX2 ends when the ejection section inspection process is performed by the normal inspection mode MD-X.

On the other hand, as described above, when the ejection section inspection process in the high-speed inspection mode MD-Y is executed, the cavity CV of the ejection section D[m] is not filled with ink (or is filled with a specific type of liquid having a lower viscosity than the ink). Thus, when the ejection section inspection process in the high-speed inspection mode MD-Y is executed, the attenuation of the vibration when the vibration propagates from the drive target ejection section DD to the ejection section D[m] designated as the inspection target ejection section DK increases as compared with the case of the normal inspection mode MD-X. Moreover, when the ejection section inspection process in the high-speed inspection mode MD-Y is executed, the vibration propagated to the inspection target ejection section DK attenuates rapidly as compared with the case of the normal inspection mode MD-X. Thus, in the present embodiment, an amplitude dVy of the detection potential signal VX[m] in the control period TSY2 when the ejection section inspection process in the high-speed inspection mode MD-Y is executed is smaller than the amplitude dVx of the detection potential signal VX[m] in the control period TSX2 when the ejection section inspection process in the normal inspection mode MD-X is executed. That is, in the present embodiment, the amplitude dVy of the detection potential signal VX[m] in the control period TSY2 when the ejection section inspection process in the high-speed inspection mode MD-Y is executed is less than the threshold dVth. That is, in the present embodiment, when the ejection section inspection process in the high-speed inspection mode MD-Y is executed and when the ejection section D[m] designated as the inspection target ejection section DK has a predetermined power storage capacity, the detection potential signal VX[m] is not equal to or greater than the threshold potential Vth from the time t4 when the control period TSY2 starts to the time t5 when the control period TSY2 ends.

FIG. 16 is a view illustrating a change in potential of the upper electrode Zu[m] when the ejection section inspection process in the high-speed inspection mode MD-Y is executed. In the figure, it is assumed that the ejection section D[m] designated as the inspection target ejection section DK does not have a predetermined power storage capacity.

As described above, in the ejection section inspection process, when the ejection section D[m] designated as the inspection target ejection section DK does not have a predetermined power storage capacity, the potential of the upper electrode Zu[m] in the control period TSY2 changes to approach the drive potential VH from the reference potential V0. Therefore, in the ejection section inspection process in the high-speed inspection mode MD-Y, when the ejection section D[m] designated as the inspection target ejection section DK does not have a predetermined power storage capacity, as illustrated in FIG. 16, the potential of the detection potential signal VX[m] changes such that vibration occurs with the amplitude dVy smaller than the threshold dVth in the control period TSY2 and the center of the amplitude approaches the drive potential VH from the reference potential V0. In the present embodiment, in the ejection section inspection process in the high-speed inspection mode MD-Y, when the ejection section D[m] designated as the inspection target ejection section DK does not have a predetermined power storage capacity, it is assumed that the drive potential VH included in the waveform PA-Y is set such that the detection potential signal VX[m] is equal to or higher than the threshold potential Vth from the time t4 when the control period TSY2 starts to the time t5 when the control period TSY2 ends. Thus, in the present embodiment, in the high-speed inspection mode MD-Y, the inspection unit 5 can inspect the state of the ejection section D[m] by inspecting whether or not the potential of the detection potential signal VX[m] in the control period TSY2 is equal to or higher than the threshold potential Vth.

In the present embodiment, it is assumed that both the potential at which the inspection drive signal Com-AX is set in the control period TSX2 and the potential at which the inspection drive signal Com-AY is set in the control period TSY2 are the drive potential VH, but the present disclosure is not limited to such an aspect. The potential at which the inspection drive signal Com-AX is set in the control period TSX2 and the potential at which the inspection drive signal Com-AY is set in the control period TSY2 may be different potentials. In this case, the potential at which the inspection drive signal Com-AX is set in the control period TSX2 may be a potential at which the detection potential signal VX[m] is equal to or higher than the threshold potential Vth in the control period TSX2 when the ejection section D[m] designated as the inspection target ejection section DK does not have a predetermined power storage capacity in the ejection section inspection process in the normal inspection mode MD-X. In addition, the potential at which the inspection drive signal Com-AY is set in the control period TSY2 may be a potential at which the detection potential signal VX[m] is equal to or higher than the threshold potential Vth in the control period TSY2 when the ejection section D[m] designated as the inspection target ejection section DK does not have a predetermined power storage capacity in the ejection section inspection process in the high-speed inspection mode MD-Y.

Hereinafter, in order to clarify the advantages of the ejection section inspection process according to the present embodiment, an ejection section inspection process according to a comparative example will be described.

In the ejection section inspection process according to the comparative example, regardless of whether or not the cavities CV of the inspection target ejection section DK and the drive target ejection section DD are filled with ink, similar to the high-speed inspection mode MD-Y according to the present embodiment, the inspection mode MD in which the unit inspection period TY is set as the operation period of the ink jet printer, the inspection drive signal Com-AY is supplied to the head unit 3 as the drive signal Com-A, and the inspection drive signal Com-BY is supplied as the drive signal Com-B.

FIG. 17 is a view illustrating a change in potential of the upper electrode Zu[m] when the ejection section inspection process according to the comparative example is executed. In the figure, it is assumed that the ejection section D[m] designated as the inspection target ejection section DK has a predetermined power storage capacity, and the inspection target ejection section DK and the drive target ejection section DD are filled with ink.

As described above, the control period TY2 in which the inspection drive signal Com-AY changes in potential from the reference potential V0 to the drive potential VH is shorter than the control period TX2 in which the inspection drive signal Com-AX changes in potential from the reference potential V0 to the drive potential VH. Therefore, when the ejection section inspection process according to the comparative example is performed, the amplitude of the vibration generated in the drive target ejection section DD at the time t3 when the control period TY2 ends is larger than the amplitude of the vibration generated in the drive target ejection section DD at the time t0 when the control period TX2 ends when the ejection section inspection process in the normal inspection mode MD-X according to the present embodiment is performed.

On the other hand, as described above, the ejection section inspection process according to the comparative example is a process assumed that the cavity CV of the ejection section D[m] is filled with ink. Thus, when the ejection section inspection process according to the comparative example is executed, the vibration propagating from the drive target ejection section DD to the ejection section D[m] designated as the inspection target ejection section DK increases as compared with when the ejection section inspection process in the normal inspection mode MD-X according to the present embodiment is executed. Moreover, when the ejection section inspection process according to the comparative example is executed, the rate of attenuation of the vibration in the inspection target ejection section DK is substantially the same as that when the ejection section inspection process in the normal inspection mode MD-X according to the present embodiment is executed. Thus, an amplitude dVz of the detection potential signal VX[m] in the control period TSY2 when the ejection section inspection process according to the comparative example is executed is larger than the amplitude dVx of the detection potential signal VX[m] in the control period TSX2 when the ejection section inspection process in the normal inspection mode MD-X according to the present embodiment is executed. For example, the amplitude dVz of the detection potential signal VX[m] in the control period TSY2 when the ejection section inspection process according to the comparative example is executed is equal to or higher than the threshold dVth. That is, in the ejection section inspection process according to the comparative example, even when the ejection section D[m] designated as the inspection target ejection section DK has a predetermined power storage capacity, the detection potential signal VX[m] is equal to or higher than the threshold potential Vth in the control period TSY2.

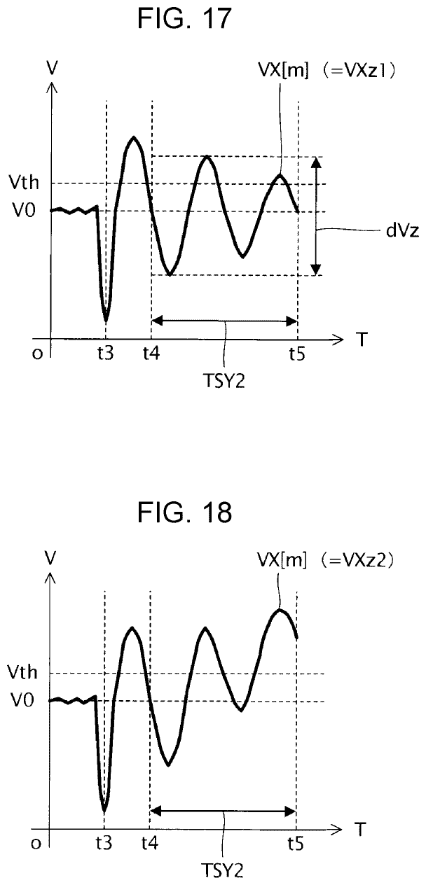

FIG. 18 is a view illustrating a change in potential of the upper electrode Zu[m] when the ejection section inspection process according to the comparative example is executed. In the figure, it is assumed that the ejection section D[m] designated as the inspection target ejection section DK does not have a predetermined power storage capacity, and the inspection target ejection section DK and the drive target ejection section DD are filled with ink.

As described above, in the ejection section inspection process, when the ejection section D[m] designated as the inspection target ejection section DK does not have a predetermined power storage capacity, the potential of the upper electrode Zu[m] in the control period TSY2 changes to approach the drive potential VH from the reference potential V0. Therefore, in the ejection section inspection process according to the comparative example, when the ejection section D[m] designated as the inspection target ejection section DK does not have a predetermined power storage capacity, as illustrated in FIG. 18, the potential of the detection potential signal VX[m] changes such that vibration occurs with the amplitude dVz equal to or greater than the threshold dVth in the control period TSY2 and the center of the amplitude approaches the drive potential VH from the reference potential V0. Then, in the ejection section inspection process according to the comparative example, when the ejection section D[m] designated as the inspection target ejection section DK does not have a predetermined power storage capacity, the detection potential signal VX[m] is equal to or higher than the threshold potential Vth in the control period TSY2. That is, in the ejection section inspection process according to the comparative example, the detection potential signal VX[m] is equal to or higher than the threshold potential Vth in the control period TSY2 regardless of the presence/absence of the predetermined power storage capacity of the ejection section D[m].

### 4. Summary of Present Embodiment

As described above, in the ejection section inspection process according to the comparative example, the time length of the control period TY2 is equal to or less than the time length of the control period TY4, in the inspection drive signal Com-AY used to drive the drive target ejection section DD. Therefore, regardless of the presence/absence of a predetermined power storage capacity in the ejection section D[m], the amplitude of the detection potential signal VX[m] in the control period TSY2 is equal to or greater than the threshold dVth, and the detection potential signal VX[m] in the control period TSY2 is equal to or greater than the threshold potential Vth. Therefore, in the ejection section inspection process according to the comparative example, it was difficult to inspect the state of the ejection section D[m] based on the detection potential signal VX[m].

On the other hand, according to the present embodiment, in the ejection section inspection process in the normal inspection mode MD-X, the time length of the control period TX2 is set to be longer than the time length of the control period TX4, in the inspection drive signal Com-AX used to drive the drive target ejection section DD. Therefore, according to the present embodiment, in the ejection section inspection process in the normal inspection mode MD-X, when the ejection section D[m] has a predetermined power storage capacity, the detection potential signal VX[m] in the control period TSX2 can be suppressed from reaching a potential equal to or higher than the threshold potential Vth, and only when the ejection section D[m] does not have the predetermined power storage capacity, the detection potential signal VX[m] in the control period TSX2 can be set to reach a potential equal to or higher than the threshold potential Vth. Accordingly, according to the present embodiment, the possibility that the inspection accuracy of the ejection section inspection process is lowered due to the vibration propagating from the drive target ejection section DD can be suppressed.

In addition, according to the present embodiment, in addition to the ejection section inspection process in the normal inspection mode MD-X, the ejection section inspection process in the high-speed inspection mode MD-Y is possible. Therefore, as compared with an aspect in which only the ejection section inspection process in the normal inspection mode MD-X can be performed, the execution time of the ejection section inspection process can be shortened when the cavity CV of the ejection section D[m] is not filled with ink (or when the cavity CV is filled with a specific type of liquid having a lower viscosity than the ink).

### B. Modification Example

Each form above can be variously modified. Specific aspects of the modification will be described below. Two or more aspects selected in any manner from the following examples can be combined with each other as appropriate within the scope of not contradicting with each other. In addition, in the modification examples described below, elements having the same effects and functions as those of the embodiment will be given the reference numerals used in the description above, and each detailed description thereof will be omitted as appropriate.

### Modification Example 1

In the above-described embodiment, a case where the drive target ejection section DD is the ejection section D different from the inspection target ejection section DK is described as an example, but the present disclosure is not limited to such an aspect. The drive target ejection section DD may be the same ejection section D as the inspection target ejection section DK.

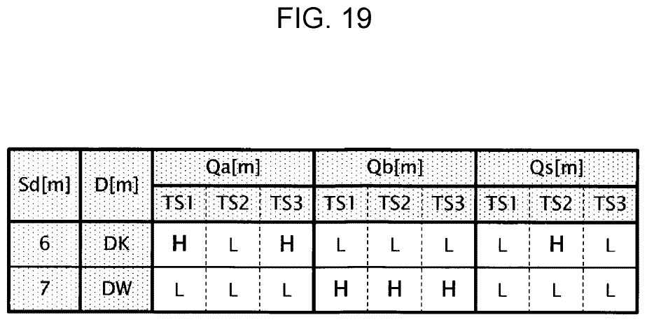

FIG. 19 is an explanatory view illustrating an example of the operation of the coupled state designation circuit 310 in the unit inspection period TXY (unit inspection period TX or unit inspection period TY) in the present modification example.

As illustrated in FIG. 19, the individual designation signal Sd[m] according to the present modification example can take any one value of two values, that is, a value “6” for designating the ejection section D[m] as the inspection target ejection section DK and a value “7” for designating the ejection section D[m] as the standby ejection section DW, in the unit inspection period TXY during which the ejection section inspection process is executed.

In the present modification example, it is assumed that the inspection target ejection section DK is a target to be driven and a target to be inspected in the ejection section inspection process. That is, in the present modification example, the inspection target ejection section DK also serves as the drive target ejection section DD according to the embodiment, in addition to the role of the inspection target ejection section DK according to the embodiment.

As illustrated in FIG. 19, in the present modification example, when the individual designation signal Sd[m] indicates the value “6” for designating the ejection section D[m] as the inspection target ejection section DK in the unit inspection period TXY, the coupled state designation circuit 310 maintains the coupled state designation signal Qa[m] at a high level in the control period TS1 and the control period TS3, and maintains the coupled state designation signal Qs[m] at a high level in the control period TS2. In this case, the switch Wa[m] is turned on in the control period TS1 and the control period TS3, and the switch Ws[m] is turned on in the control period TS2. Therefore, the ejection section D[m] is driven by the inspection drive signal Com-AXY (inspection drive signal Com-AX or inspection drive signal Com-AY) having the waveform PA-XY (waveform PA-X or waveform PA-Y) in the control period TS1, and the upper electrode Zu[m] included in the ejection section D[m] changes in potential from the reference potential V0 to the drive potential VH. Then, the detection circuit 33 detects the potential of the upper electrode Zu[m] included in the ejection section D[m] as the detection potential signal VX[m] via the switch Ws[m] in the control period TS2 (control period TSX2 or control period TSY2). In addition, when the individual designation signal Sd[m] indicates the value “7” for designating the ejection section D[m] as the standby ejection section DW in the unit inspection period TXY, the coupled state designation circuit 310 maintains the coupled state designation signal Qb[m] at a high level throughout the unit inspection period TXY. In this case, the potential of the ejection section D[m] in the control period TS2 (control period TSX2 or control period TSY2) is set to the reference potential V0.

In the present modification example, it is assumed that, in each unit inspection period TXY, one ejection section D[m] among the M ejection sections D[1] to D[M] is designated as the inspection target ejection section DK, and the remaining (M-1) ejection sections D are designated as the standby ejection sections DW.

In the present modification example, when the ejection section D[m] driven as the inspection target ejection section DK has a predetermined power storage capacity, the potential of the upper electrode Zu[m] in the control period TS2 is maintained at the drive potential VH. On the other hand, in the present modification example, when the ejection section D[m] driven as the inspection target ejection section DK does not have a predetermined power storage capacity, that is, when the short-circuit path LK is present between the upper electrode Zu[m] included in the ejection section D[m] designated as the inspection target ejection section DK and the upper electrode Zu included in the ejection section D designated as the standby ejection section DW, the potential of the upper electrode Zu[m] changes to approach the reference potential V0 from the drive potential VH in the control period TS2. Therefore, in the present modification example, the detection circuit 33 can inspect whether or not the ejection section D[m] has a predetermined power storage capacity by determining whether or not the potential change amount of the detection potential signal VX[m] in the control period TS2 is smaller than the threshold potential Vth based on the detection signal SK[m].

### Modification Example 2

In the above-described embodiment and Modification Example 1, when the ejection section inspection process is executed in the normal inspection mode MD-X, a case where the inspection drive signal Com-AX is supplied to the head unit 3 as the drive signal Com-A is described as an example, but the present disclosure is not limited to such an aspect. For example, when the ejection section inspection process is executed in the normal inspection mode MD-X, the head unit 3 may be supplied with a signal having a waveform different from that of the inspection drive signal Com-AX as the drive signal Com-A.

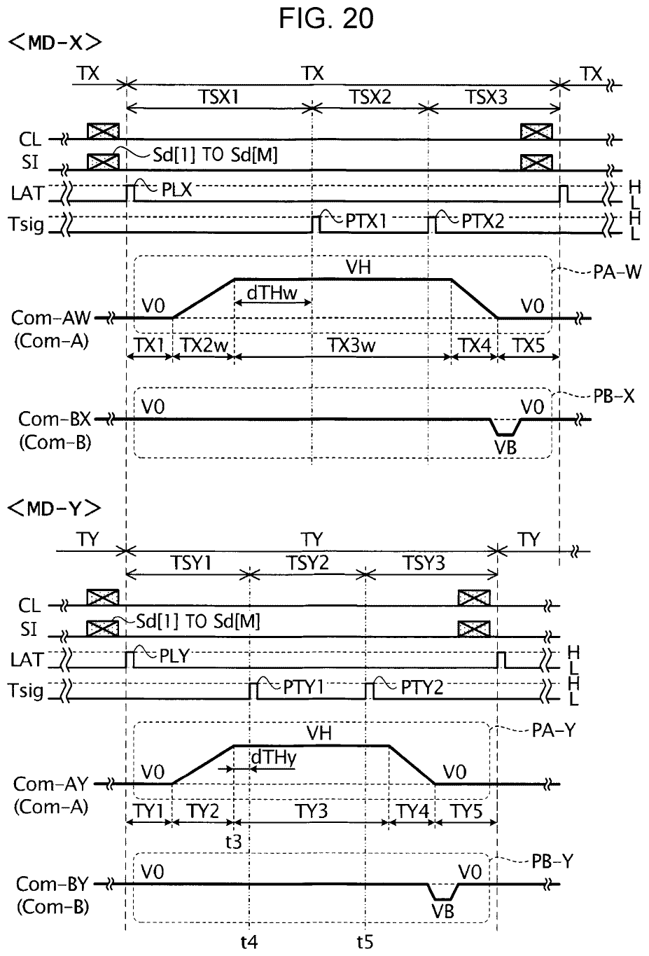

FIG. 20 is a timing chart illustrating an example of various signals, such as the drive signal Com supplied to the head unit 3 in the unit inspection period TX and the unit inspection period TY according to the present modification example.

As illustrated in FIG. 20, in the present modification example, the ejection section inspection process is different from the ejection section inspection process according to the embodiment in that, when the ejection section inspection process is executed, an inspection drive signal Com-AW is supplied to the head unit 3 instead of the inspection drive signal Com-AX.

As illustrated in FIG. 20, the inspection drive signal Com-AW has a waveform PA-W provided in the unit inspection period TX. Here, the waveform PA-W is a waveform that maintains the reference potential V0 in the control period TX1 of the unit inspection period TX, changes in potential from the reference potential V0 to the drive potential VH in a control period TX2w, following the control period TX1, of the unit inspection period TX, maintains the drive potential VH in a control period TX3w, following the control period TX2w, of the unit inspection period TX, changes in potential from the drive potential VH to the reference potential V0 in the control period TX4, following the control period TX3w, of the unit inspection period TX, and maintains the reference potential V0 in the control period TX5, following the control period TX4, of the unit inspection period TX. Among these, the control period TX2w is included in the control period TSX1, and starts after the start of the control period TSX1 and ends before the end of the control period TSX1. In addition, in the present modification example, the time length of the control period TX2w is the same as the time length of the control period TY2. In addition, the control period TX3w includes part of the control period TSX1, the entire control period TSX2, and part of the control period TSX3, starts after the start of the control period TSX1 and before the start of the control period TSX2, and ends after the end of the control period TSX2 and before the end of the control period TSX3. That is, in the present modification example, the control period TSX2 is included in the control period TX3w. In addition, in the present modification example, the time length of the control period TX3w is longer than the time length of the control period TY3. Specifically, an interval dTHw from the start of the control period TX3w to the start of the control period TSX2 is longer than an interval dTHv from the start of the control period TY3 to the start of the control period TSY2.

As described above, according to the present modification example, the interval dTHw from when the drive target ejection section DD is driven by the inspection drive signal Com-AW used in the normal inspection mode MD-X to when the detection circuit 33 starts detecting the detection potential signal VX[m] from the inspection target ejection section DK is longer than the interval dTHv from when the drive target ejection section DD is driven by the inspection drive signal Com-AY used in the high-speed inspection mode MD-Y to when the detection circuit 33 starts detecting the detection potential signal VX[m] from the inspection target ejection section DK. Therefore, according to the present modification example, for example, the amplitude of the vibration of the detection potential signal VX[m] caused by the vibration propagating from the drive target ejection section DD to the inspection target ejection section DK can be attenuated more significantly as compared with the ejection section inspection process according to the comparative example. Accordingly, according to the present modification example, the possibility that the inspection accuracy of the ejection section inspection process is lowered due to the vibration propagated from the drive target ejection section DD can be suppressed.

### Modification Example 3

In the above-described embodiment and Modification Examples 1 and 2, a case where the ink jet printer 1 can execute the ejection section inspection process in the two inspection modes MD of the normal inspection mode MD-X and the high-speed inspection mode MD-Y is described as an example, but the present disclosure is not limited to such an aspect. The ink jet printer 1 may be able to execute the ejection section inspection process in at least the normal inspection mode MD-X.

### Modification Example 4

In the above-described embodiment and Modification Examples 2 and 3, a case where the inspection target ejection section DK and the drive target ejection section DD are the ejection sections D adjacent to each other is described as an example, but the present disclosure is not limited to such an aspect. The inspection target ejection section DK and the drive target ejection section DD may be ejection sections D that are not adjacent to each other.

### Modification Example 5

In the above-described embodiment and Modification Examples 1 to 4, it is assumed that the ink jet printer 1 includes four head units 3, but the present disclosure is not limited to such an aspect. The ink jet printer 1 may include one or more head units 3 and three or less head units 3, or may include five or more head units 3.

### Modification Example 6

In the above-described embodiment and Modification Examples 1 to 5, it is assumed that the ink jet printer 1 is a serial printer is described, but the present disclosure is not limited to such an aspect. The ink jet printer 1 may be a so-called line printer in which a plurality of nozzles N are provided in the head unit 3 to extend wider than the width of the recording paper PP.

### C. Appendix

The aspects related to the above embodiment and modification examples are listed below. In addition, in order to facilitate understanding of each aspect, the following description will be made with reference to the accompanying drawings, but it is not intended that the present disclosure be limited to the illustrated aspects.

### C. 1. Appendix 1

Hereinafter, Appendix 1 will be described. In addition, in the following, a variable m1 is a natural number satisfying “1≤m1≤M”, and a variable m2 is a natural number satisfying “1≤m2≤M” and “m1≠m2”.

### Appendix 1-1

The ink jet printer 1 according to Appendix 1-1 includes: the inspection target ejection section DK that includes the piezoelectric element PZ[m1] that is displaced in response to the drive signal Com and that is configured to eject ink in response to the displacement of the piezoelectric element PZ[m1]; the drive target ejection section DD that includes the piezoelectric element PZ[m2] that is displaced in response to the drive signal Com and that is configured to eject ink in response to the displacement of the piezoelectric element PZ[m2], and the inspection unit 5 that inspects the state of the inspection target ejection section DK based on the detection signal SK[m1] according to the potential of the piezoelectric element PZ[m1] in the control period TSX2 included in the unit inspection period TX when the drive signal Com (more specifically, the inspection drive signal Com-AX) is supplied to the piezoelectric element PZ[m2] in the unit inspection period TX, the drive signal Com maintains the reference potential V0 in the control period TX1 of the unit inspection period TX, changes in potential from the reference potential V0 to the drive potential VH in the control period TX2, following the control period TX1, of the unit inspection period TX, maintains the drive potential VH in the control period TX3, following the control period TX2, of the unit inspection period TX, changes in potential from the drive potential VH to the reference potential V0 in the control period TX4, following the control period TX3, of the unit inspection period TX, and maintains the reference potential V0 in the control period TX5, following the control period TX4, of the unit inspection period TX, the control period TX3 includes the control period TSX2, and the control period TX2 is longer than the control period TX4. In addition, in Appendix 1, the piezoelectric element PZ[m1] is an example of a “first piezoelectric element”, the piezoelectric element PZ[m2] is an example of a “second piezoelectric element”, the inspection target ejection section DK is an example of a “first ejection section”, the drive target ejection section DD is an example of a “second ejection section”, the inspection unit 5 is an example of an “inspection section”, the unit inspection period TX is an example of a “unit period”, the control period TSX2 is an example of an “inspection period”, the control period TX1 is an example of a “first period”, the control period TX2 is an example of a “second period”, the control period TX3 is an example of a “third period”, the control period TX4 is an example of a “fourth period”, the control period TX5 is an example of a “fifth period”, the reference potential V0 is an example of a “first potential”, and the drive potential VH is an example of a “second potential”.

According to Appendix 1-1, the control period TX2 is longer than the control period TX4, and the vibration generated in the drive target ejection section DD can be suppressed at the timing at which the control period TX2 ends. Therefore, the noise that is superimposed on the detection signal SK[m1] due to the vibration propagating from the drive target ejection section DD to the inspection target ejection section DK can be reduced. In addition, according to Appendix 1-1, the control period TX4 is set to be shorter than the control period TX2. Therefore, the time length of the unit inspection period TX required for the inspection of the state of the inspection target ejection section DK can be shortened.

### Appendix 1-2

The ink jet printer 1 according to Appendix 1-2 is the ink jet printer 1 according to Appendix 1-1, in which, in the unit inspection period TX, the inspection target ejection section DK and the drive target ejection section DD are filled with the ink.

According to Appendix 1-2, the inspection of the state of the inspection target ejection section DK is performed in a state in which the inspection target ejection section DK and the drive target ejection section DD are filled with ink. Therefore, the labor required for switching between the formation of an image by ejecting ink from the ink jet printer 1 and the inspection of the inspection target ejection section DK can be reduced, as compared with the aspect in which the inspection of the state of the inspection target ejection section DK is performed in a state in which the inspection target ejection section DK and the drive target ejection section DD are not filled with the ink.

### Appendix 1-3

The ink jet printer 1 according to Appendix 1-3 is the ink jet printer 1 according to Appendix 1-1 or 1-2, in which a flow path provided in the inspection target ejection section DK and a flow path provided in the drive target ejection section DD communicate with the common liquid chamber 327 that stores the ink.

According to Appendix 1-3, the vibration generated in the drive target ejection section DD in response to the drive of the drive target ejection section DD by the drive signal Com propagates to the inspection target ejection section DK via the common liquid chamber 327, but the control period TX2 is longer than the control period TX4, and the vibration generated in the drive target ejection section DD is suppressed. Therefore, the noise that is superimposed on the detection signal SK[m1] due to the vibration propagating from the drive target ejection section DD to the inspection target ejection section DK can be reduced.

### Appendix 1-4

The ink jet printer 1 according to Appendix 1-4 includes: the inspection target ejection section DK that includes the piezoelectric element PZ[m1] that is displaced in response to the drive signal Com and that is configured to eject ink in response to the displacement of the piezoelectric element PZ[m1], the inspection unit 5 that inspects the state of the inspection target ejection section DK based on the detection signal SK[m1] according to the potential of the piezoelectric element PZ[m1] in the control period TSX2 included in the unit inspection period TX when the drive signal Com (more specifically, the inspection drive signal Com-AX) is supplied to the piezoelectric element PZ[m1] in the control period TSX1 included in the unit inspection period TX, the drive signal Com maintains the reference potential V0 in the control period TX1 of the unit inspection period TX, changes in potential from the reference potential V0 to the drive potential VH in the control period TX2, following the control period TX1, of the unit inspection period TX, maintains the drive potential VH in the control period TX3, following the control period TX2, of the unit inspection period TX, changes in potential from the drive potential VH to the reference potential V0 in the control period TX4, following the control period TX3, of the unit inspection period TX, and maintains the reference potential V0 in the control period TX5, following the control period TX4, of the unit inspection period TX, the control period TX3 includes the control period TSX2, and the control period TSX1 does not include the control period TSX2, and includes at least the control period TX2, and the control period TX2 is longer than the control period TX4. In addition, in Appendix 1, the control period TSX1 is an example of a “drive period”.

According to Appendix 1-1, the control period TX2 is longer than the control period TX4, and the vibration generated in the inspection target ejection section DK can be suppressed at the timing at which the control period TX2 ends. Therefore, the noise that is superimposed on the detection signal SK[m1] due to the vibration generated in the inspection target ejection section DK can be reduced. In addition, according to Appendix 1-1, the control period TX4 is set to be shorter than the control period TX2. Therefore, the time length of the unit inspection period TX required for the inspection of the state of the inspection target ejection section DK can be shortened.

### Appendix 1-5

The ink jet printer 1 according to Appendix 1-5 is the ink jet printer 1 according to Appendix 1-1 to Appendix 1-4, in which the inspection unit 5 outputs the inspection result signal SS[m] indicating that the state of the inspection target ejection section DK is abnormal when the change in potential of the piezoelectric element PZ[m1] is equal to or greater than the threshold dVth in the control period TSX2. In addition, in Appendix 1, the threshold dVth is an example of a “reference amount”, and the inspection result signal SS[m] is an example of an “inspection result”.

According to Appendix 1-5, whether or not the piezoelectric element PZ[m1] has a predetermined power storage capacity can be inspected based on the change in potential of the piezoelectric element PZ[m1] in the control period TSX2.

### Appendix 1-6

The ink jet printer 1 according to Appendix 1-6 includes: the inspection target ejection section DK that includes the piezoelectric element PZ[m1] that is displaced in response to the drive signal Com and that is configured to eject ink in response to the displacement of the piezoelectric element PZ[m1], the drive target ejection section DD that includes the piezoelectric element PZ[m2] that is displaced in response to the drive signal Com and that is configured to eject ink in response to the displacement of the piezoelectric element PZ[m2], and the inspection unit 5 that inspects the state of the inspection target ejection section DK based on the detection signal SK[m1] according to the potential of the piezoelectric element PZ[m1] in the control period TSX2 included in the unit inspection period TX when the drive signal Com (more specifically, the inspection drive signal Com-AX) is supplied to the piezoelectric element PZ[m2] in the unit inspection period TX, the drive signal Com changes in potential from the reference potential V0 to the drive potential VH in the control period TX2 of the unit inspection period TX, maintains the drive potential VH in the control period TX3, following the control period TX2, of the unit inspection period TX, changes in potential from the drive potential VH to the reference potential V0 in the control period TX4, following the control period TX3, of the unit inspection period TX, the control period TX3 includes the control period TSX2, and the control period TX2 is longer than the control period TX4. In addition, in Appendix 1, the control period TX2 is an example of the “first transition period”, the control period TX3 is an example of the “maintenance period”, and the control period TX4 is an example of the “second transition period”.

### C. 2. Appendix 2

Hereinafter, Appendix 2 will be described. In addition, in Appendix 2, the control period TX1 and the control period TY1 may be referred to as a control period TXY1, the control period TX2 and the control period TY2 may be referred to as a control period TXY2, the control period TX3 and the control period TY3 may be referred to as a control period TXY3, the control period TX4 and the control period TY4 may be referred to as a control period TXY4, and the control period TX5 and the control period TY5 may be referred to as a control period TXY5.

### Appendix 2-1

The ink jet printer 1 according to Appendix 2-1 includes: the inspection target ejection section DK that includes the piezoelectric element PZ[m1] that is displaced in response to the drive signal Com and that is configured to eject ink in response to the displacement of the piezoelectric element PZ[m1], the drive target ejection section DD that includes the piezoelectric element PZ[m2] that is displaced in response to the drive signal Com and that is configured to eject the ink in response to the displacement of the piezoelectric element PZ[m2], and the inspection unit 5 that inspects the state of the inspection target ejection section DK based on the detection signal SK[m1] according to the potential of the piezoelectric element PZ[m1] in the control period TS2 included in the unit inspection period TXY when the drive signal Com (more specifically, the inspection drive signal Com-AXY) is supplied to the piezoelectric element PZ[m2] in the unit inspection period TXY, the inspection unit 5 is configured to inspect the first inspection target ejection section DK in a plurality of inspection modes MD including the normal inspection mode MD-X that inspects the state of the inspection target ejection section DK in a state in which the inspection target ejection section DK and the drive target ejection section DD are filled with ink, and the high-speed inspection mode MD-Y that inspects the state of the inspection target ejection section DK in a time shorter than the normal inspection mode MD-X, the drive signal Com maintains the reference potential V0 in the control period TXY1 of the unit inspection period TXY, changes in potential from the reference potential V0 to the drive potential VH in the control period TXY2, following the control period TXY1, of the unit inspection period TXY, maintains the drive potential VH in the control period TXY3, following the control period TXY2, of the unit inspection period TXY, changes in potential from the drive potential VH to the reference potential V0 in the control period TXY4, following the control period TXY3, of the unit inspection period TXY, and maintains the reference potential V0 in the control period TXY5, following the control period TXY4, of the unit inspection period TXY, the control period TXY3 includes the control period TS2, and the time length of the control period TXY2 (that is, the control period TX2) in the normal inspection mode MD-X is longer than the time length of the control period TXY2 (that is, the control period TY2) in the high-speed inspection mode MD-Y. In addition, in Appendix 2, the piezoelectric element PZ[m1] is an example of a “first piezoelectric element”, the piezoelectric element PZ[m2] is an example of a “second piezoelectric element”, the inspection target ejection section DK is an example of a “first ejection section”, the drive target ejection section DD is an example of a “second ejection section”, the inspection unit 5 is an example of an “inspection section”, the normal inspection mode MD-X is an example of a “first inspection mode”, the high-speed inspection mode MD-Y is an example of a “second inspection mode”, the unit inspection period TXY is an example of a “unit period”, the control period TS2 is an example of an “inspection period”, the control period TXY1 is an example of a “first period”, the control period TXY2 is an example of a “second period”, the control period TXY3 is an example of a “third period”, the control period TXY4 is an example of a “fourth period”, the control period TXY5 is an example of a “fifth period”, the reference potential V0 is an example of a “first potential”, and the drive potential VH is an example of a “second potential”.

When the drive target ejection section DD is driven by the drive signal Com, the drive target ejection section DD vibrates. When the drive target ejection section DD is filled with ink, the vibration generated in the drive target ejection section DD remains for a long period of time as compared with a case where the drive target ejection section DD is not filled with the ink. In addition, when the drive target ejection section DD is driven by the drive signal Com and the drive target ejection section DD and when the inspection target ejection section DK are filled with ink, strong vibration propagates from the drive target ejection section DD to the inspection target ejection section DK as compared with a case where the drive target ejection section DD and the inspection target ejection section DK are not filled with the ink. Therefore, when the drive target ejection section DD and the inspection target ejection section DK are filled with ink, noise is superimposed on the detection signal SK[m1] due to the vibration propagated from the drive target ejection section DD to the inspection target ejection section DK. Accordingly, in the ejection section inspection process, the inspection accuracy of the inspection target ejection section DK based on the detection signal SK[m1] may be lowered. On the other hand, according to Appendix 2-1, the ejection section inspection process in the normal inspection mode MD-X in which the control period TXY2 is set to be long can be performed in a state in which the drive target ejection section DD and the inspection target ejection section DK are filled with ink. Therefore, according to Appendix 2-1, as compared with the aspect in which only the ejection section inspection process in the high-speed inspection mode MD-Y can be performed, the vibration propagating from the drive target ejection section DD to the inspection target ejection section DK can be reduced, and the inspection accuracy of the inspection target ejection section DK in the ejection section inspection process can be improved. In addition, according to Appendix 2-1, the ejection section inspection process in the high-speed inspection mode MD-Y, in which the inspection can be performed in a time shorter than the normal inspection mode MD-X, can be performed. Therefore, when the vibration propagating from the drive target ejection section DD to the inspection target ejection section DK is small, the ejection section inspection process can be executed in a short time.

### Appendix 2-2

The ink jet printer 1 according to Appendix 2-2 is the ink jet printer 1 according to Appendix 2-1, in which the high-speed inspection mode MD-Y is an inspection mode MD in which the state of the inspection target ejection section DK is inspected in a state in which the inspection target ejection section DK and the drive target ejection section DD are not filled with ink.

According to Appendix 2-2, the ejection section inspection process in the high-speed inspection mode MD-Y in which the control period TXY2 is set to be short is executed in a state in which the drive target ejection section DD is not filled with ink. In a state in which the drive target ejection section DD is not filled with ink, as compared with a state in which the drive target ejection section DD is filled with the ink, the vibration generated in the drive target ejection section DD when the drive target ejection section DD is driven by the drive signal Com disappears in a short time. Therefore, a decrease in the inspection accuracy of the ejection section inspection process due to the vibration propagating from the drive target ejection section DD to the inspection target ejection section DK can be suppressed. Thus, according to Appendix 2-2, both the suppression of a decrease in the inspection accuracy of the ejection section inspection process and the acceleration of the ejection section inspection process can be achieved.

### Appendix 2-3

The ink jet printer 1 according to Appendix 2-3 is the ink jet printer 1 according to Appendix 2-1, in which the normal inspection mode MD-X is an inspection mode MD in which the state of the inspection target ejection section DK is inspected in a state in which the inspection target ejection section DK and the drive target ejection section DD are filled with ink, and the high-speed inspection mode MD-Y is an inspection mode MD in which the state of the inspection target ejection section DK is inspected in a state in which the inspection target ejection section DK and the drive target ejection section DD are filled with a specific type of liquid having a lower viscosity than the ink. In addition, in Appendix 2, the ink is an example of a “first type of liquid”, and the specific type of liquid is an example of a “second type of liquid”.

According to Appendix 2-3, the ejection section inspection process in the normal inspection mode MD-X in which the control period TXY2 is set to be long is executed in a state in which the drive target ejection section DD is filled with ink having a high viscosity, and the ejection section inspection process in the high-speed inspection mode MD-Y in which the control period TXY2 is set to be short is executed in a state in which the drive target ejection section DD is filled with the specific type of liquid a low viscosity. Thus, according to Appendix 2-3, when the drive target ejection section DD is filled with the high-viscosity ink and the vibration generated in the drive target ejection section DD remains for a long time, the vibration generated in the drive target ejection section DD is suppressed, and a decrease in the inspection accuracy of the ejection section inspection process due to the vibration propagating from the drive target ejection section DD to the inspection target ejection section DK is suppressed. When the drive target ejection section DD is filled with the specific type of liquid having a low viscosity and the vibration generated in the drive target ejection section DD disappears in a short time, the acceleration of the ejection section inspection process is prioritized over the suppression of the vibration generated in the drive target ejection section DD. Therefore, according to Appendix 2-3, both the suppression of a decrease in the inspection accuracy of the ejection section inspection process and the acceleration of the ejection section inspection process can be achieved.

### Appendix 2-4

The ink jet printer 1 according to Appendix 2-4 includes: the inspection target ejection section DK that includes the piezoelectric element PZ[m1] that is displaced in response to the drive signal Com and that is configured to eject ink in response to the displacement of the piezoelectric element PZ[m1], and the inspection unit 5 that inspects the state of the inspection target ejection section DK based on the detection signal SK[m1] according to the potential of the piezoelectric element PZ[m1] in the control period TS2 included in the unit inspection period TXY when the drive signal Com (more specifically, the inspection drive signal Com-AXY) is supplied to the piezoelectric element PZ[m1] in the control period TS1 included in the unit inspection period TXY, the inspection unit 5 is configured to inspect the first inspection target ejection section DK in a plurality of inspection modes MD including the normal inspection mode MD-X that inspects the state of the inspection target ejection section DK in a state in which the inspection target ejection section DK is filled with the ink, and the high-speed inspection mode MD-Y that inspects the state of the inspection target ejection section DK in a time shorter than the normal inspection mode MD-X, the drive signal Com maintains the reference potential V0 in the control period TXY1 of the unit inspection period TXY, changes in potential from the reference potential V0 to the drive potential VH in the control period TXY2, following the control period TXY1, of the unit inspection period TXY, maintains the drive potential VH in the control period TXY3, following the control period TXY2, of the unit inspection period TXY, changes in potential from the drive potential VH to the reference potential V0 in the control period TXY4, following the control period TXY3, of the unit inspection period TXY, and maintains the reference potential V0 in the control period TXY5, following the control period TXY4, of the unit inspection period TXY, the control period TXY3 includes the control period TS2, and the control period TS1 does not include the control period TS2, and includes at least the control period TXY2, and the time length of the control period TXY2 (that is, the control period TX2) in the normal inspection mode MD-X is longer than the time length of the control period TXY2 (that is, the control period TY2) in the high-speed inspection mode MD-Y. In addition, in Appendix 2, the control period TS1 is an example of a “drive period”.

According to Appendix 2-4, the ejection section inspection process in the normal inspection mode MD-X in which the control period TXY2 is set to be long can be performed in a state in which the inspection target ejection section DK is filled with ink. Therefore, according to Appendix 2-4, as compared with the aspect in which only the ejection section inspection process in the high-speed inspection mode MD-Y can be performed, the vibration occurring in the inspection target ejection section DK can be reduced, and the inspection accuracy of the inspection target ejection section DK in the ejection section inspection process can be improved. In addition, according to Appendix 2-4, the ejection section inspection process in the high-speed inspection mode MD-Y, in which the inspection can be performed in a time shorter than the normal inspection mode MD-X, can be performed. Therefore, when the vibration generated in the inspection target ejection section DK is small, the ejection section inspection process can be executed in a short time.

### Appendix 2-5

The ink jet printer 1 according to Appendix 2-5 is the ink jet printer 1 according to Appendix 2-1-and Appendix 2-4, in which the inspection unit 5 outputs the inspection result signal SS[m] indicating that the state of the inspection target ejection section DK is abnormal when the change in potential of the piezoelectric element PZ[m1] is equal to or greater than the threshold dVth in the control period TS2. In addition, in Appendix 2, the threshold dVth is an example of a “reference amount”, and the inspection result signal SS[m] is an example of an “inspection result”.

According to Appendix 2-5, whether or not the piezoelectric element PZ[m1] has a predetermined power storage capacity can be inspected based on the change in potential of the piezoelectric element PZ[m1] in the control period TS2.

### Appendix 2-6

The ink jet printer 1 according to Appendix 2-6 includes: the inspection target ejection section DK that includes the piezoelectric element PZ[m1] that is displaced in response to the drive signal Com and that is configured to eject ink in response to the displacement of the piezoelectric element PZ[m1], the drive target ejection section DD that includes the piezoelectric element PZ[m2] that is displaced in response to the drive signal Com and that is configured to eject the ink in response to the displacement of the piezoelectric element PZ[m2], and the inspection unit 5 that inspects the state of the inspection target ejection section DK based on the detection signal SK[m1] according to the potential of the piezoelectric element PZ[m1] in the control period TS2 included in the unit inspection period TXY when the drive signal Com (more specifically, the inspection drive signal Com-AXY) is supplied to the piezoelectric element PZ[m2] in the unit inspection period TXY, the inspection unit 5 is configured to inspect the first inspection target ejection section DK in a plurality of inspection modes MD including the normal inspection mode MD-X that inspects the state of the inspection target ejection section DK in a state in which the inspection target ejection section DK and the drive target ejection section DD are filled with ink, and the high-speed inspection mode MD-Y that inspects the state of the inspection target ejection section DK in a time shorter than the normal inspection mode MD-X, the drive signal Com changes in potential from the reference potential V0 to the drive potential VH in the control period TXY2 of the unit inspection period TXY, maintains the drive potential VH in the control period TXY3, following the control period TXY2, of the unit inspection period TXY, changes in potential from the drive potential VH to the reference potential V0 in the control period TXY4, following the control period TXY3, of the unit inspection period TXY, the control period TXY3 includes the control period TS2, and the time length of the control period TXY2 (that is, the control period TX2) in the normal inspection mode MD-X is longer than the time length of the control period TXY2 (that is, the control period TY2) in the high-speed inspection mode MD-Y. In addition, in Appendix 2, the control period TXY2 is an example of a “first transition period”, the control period TXY3 is an example of a “maintenance period”, and the control period TXY4 is an example of a “second transition period”.

What is claimed is:

1. A liquid ejecting apparatus comprising:
a first ejection section that includes a first piezoelectric element that is displaced in response to a drive signal and that is configured to eject a liquid in response to the displacement of the first piezoelectric element;
a second ejection section that includes a second piezoelectric element that is displaced in response to the drive signal and that is configured to eject the liquid in response to the displacement of the second piezoelectric element; and
an inspection section that, when the drive signal is supplied to the second piezoelectric element in a unit period, inspects a state of the first ejection section based on a detection signal according to a potential of the first piezoelectric element in an inspection period included in the unit period, wherein
the inspection section is configured to inspect the first ejection section in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period, and
a time length of the second period in the first inspection mode is longer than a time length of the second period in the second inspection mode.

2. The liquid ejecting apparatus according to claim 1, wherein
the second inspection mode is an inspection mode in which the state of the first ejection section is inspected in a state in which the first ejection section and the second ejection section are not filled with the liquid.

3. The liquid ejecting apparatus according to claim 1, wherein
the first inspection mode is an inspection mode in which the state of the first ejection section is inspected in a state in which the first ejection section and the second ejection section are filled with a first type of liquid, and
the second inspection mode is an inspection mode in which the state of the first ejection section is inspected in a state in which the first ejection section and the second ejection section are filled with a second type of liquid having a lower viscosity than the first type of liquid.

4. A liquid ejecting apparatus comprising:
a first ejection section that includes a first piezoelectric element that is displaced in response to a drive signal and that is configured to eject a liquid in response to the displacement of the first piezoelectric element; and
an inspection section that, when the drive signal is supplied to the first piezoelectric element in a drive period included in a unit period, inspects a state of the first ejection section based on a detection signal according to a potential of the first piezoelectric element in an inspection period included in the unit period, wherein the inspection section is configured to inspect the first ejection section in a plurality of inspection modes including:
a first inspection mode in which the state of the first ejection section is inspected in a state in which the first ejection section is filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period,
the drive period does not include the inspection period and includes at least the second period, and
a time length of the second period in the first inspection mode is longer than a time length of the second period in the second inspection mode.

5. A liquid ejecting apparatus comprising:
a first ejection section that includes a first piezoelectric element that is displaced in response to a drive signal and that is configured to eject a liquid in response to the displacement of the first piezoelectric element;
a second ejection section that includes a second piezoelectric element that is displaced in response to the drive signal and that is configured to eject the liquid in response to the displacement of the second piezoelectric element; and
an inspection section that, when the drive signal is supplied to the second piezoelectric element in a unit period, inspects a state of the first ejection section based on a detection signal according to a potential of the first piezoelectric element in an inspection period included in the unit period, wherein the inspection section is configured to inspect the first ejection section in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
changes in potential from a first potential to a second potential in a first transition period of the unit period,
maintains the second potential in a maintenance period, following the first transition period, of the unit period, and
changes in potential from the second potential to the first potential in a second transition period, following the maintenance period, of the unit period,
the maintenance period includes the inspection period, and
a time length of the first transition period in the first inspection mode is longer than a time length of the first transition period in the second inspection mode.

6. The liquid ejecting apparatus according to claim 1, wherein
when a change amount in potential of the first piezoelectric element in the inspection period is equal to or greater than a reference amount, the inspection section outputs an inspection result indicating that the state of the first ejection section is abnormal.

7. A head unit comprising:
a first ejection section that includes a first piezoelectric element that is displaced in response to a drive signal and that is configured to eject a liquid in response to the displacement of the first piezoelectric element;
a second ejection section that includes a second piezoelectric element that is displaced in response to the drive signal and that is configured to eject the liquid in response to the displacement of the second piezoelectric element; and
a detection section that, when the drive signal is supplied to the second piezoelectric element in a unit period, detects a potential of the first piezoelectric element in an inspection period included in the unit period and supplies a detection signal according to a detection result to an inspection section that inspects a state of the first ejection section based on the detection signal, wherein
the inspection section is configured to inspect the first ejection section in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period, and
a time length of the second period in the first inspection mode is longer than a time length of the second period in the second inspection mode.

8. The head unit according to claim 7, wherein
the second inspection mode is an inspection mode in which the state of the first ejection section is inspected in a state in which the first ejection section and the second ejection section are not filled with the liquid.

9. The head unit according to claim 7, wherein
the first inspection mode is an inspection mode in which the state of the first ejection section is inspected in a state in which the first ejection section and the second ejection section are filled with a first type of liquid, and
the second inspection mode is an inspection mode in which the state of the first ejection section is inspected in a state in which the first ejection section and the second ejection section are filled with a second type of liquid having a lower viscosity than the first type of liquid.

10. A head unit comprising:
a first ejection section that includes a first piezoelectric element that is displaced in response to a drive signal and that is configured to eject a liquid in response to the displacement of the first piezoelectric element; and
a detection section that, when the drive signal is supplied to the first piezoelectric element in a drive period included in a unit period, detects a potential of the first piezoelectric element in an inspection period included in the unit period and supplies a detection signal according to a detection result to an inspection section that inspects a state of the first ejection section based on the detection signal, wherein
the inspection section is configured to inspect the first ejection section in a plurality of inspection modes including:
a first inspection mode in which the state of the first ejection section is inspected in a state in which the first ejection section is filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period,
the drive period does not include the inspection period and includes at least the second period, and
a time length of the second period in the first inspection mode is longer than a time length of the second period in the second inspection mode.

11. A head unit comprising:
a first ejection section that includes a first piezoelectric element that is displaced in response to a drive signal and that is configured to eject a liquid in response to the displacement of the first piezoelectric element;
a second ejection section that includes a second piezoelectric element that is displaced in response to the drive signal and that is configured to eject the liquid in response to the displacement of the second piezoelectric element; and
a detection section that, when the drive signal is supplied to the second piezoelectric element in a unit period, detects a potential of the first piezoelectric element in an inspection period included in the unit period and supplies a detection signal according to a detection result to an inspection section that inspects a state of the first ejection section based on the detection signal, wherein
the inspection section is configured to inspect the first ejection section in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
changes in potential from a first potential to a second potential in a first transition period of the unit period,
maintains the second potential in a maintenance period, following the first transition period, of the unit period, and
changes in potential from the second potential to the first potential in a second transition period, following the maintenance period, of the unit period,
the maintenance period includes the inspection period, and
a time length of the first transition period in the first inspection mode is longer than a time length of the first transition period in the second inspection mode.

12. The head unit according to claim 7, wherein
when a change amount in potential of the first piezoelectric element in the inspection period is equal to or greater than a reference amount, the inspection section outputs an inspection result indicating that the state of the first ejection section is abnormal.

13. An inspection method for a liquid ejecting apparatus including:
a first ejection section that includes a first piezoelectric element that is displaced in response to a drive signal and that is configured to eject a liquid in response to the displacement of the first piezoelectric element; and
a second ejection section that includes a second piezoelectric element that is displaced in response to the drive signal and that is configured to eject the liquid in response to the displacement of the second piezoelectric element,
the inspection method comprising:
when the drive signal is supplied to the second piezoelectric element in a unit period, inspecting a state of the first ejection section based on a detection signal according to a potential of the first piezoelectric element in an inspection period included in the unit period, wherein
the inspection of the state of the first ejection section is configured to be executed in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period, and
a time length of the second period in the first inspection mode is longer than a time length of the second period in the second inspection mode.

14. The inspection method according to claim 13, wherein
the second inspection mode is an inspection mode in which the state of the first ejection section is inspected in a state in which the first ejection section and the second ejection section are not filled with the liquid.

15. The inspection method according to claim 13, wherein
the first inspection mode is an inspection mode in which the state of the first ejection section is inspected in a state in which the first ejection section and the second ejection section are filled with a first type of liquid, and
the second inspection mode is an inspection mode in which the state of the first ejection section is inspected in a state in which the first ejection section and the second ejection section are filled with a second type of liquid having a lower viscosity than the first type of liquid.

16. An inspection method for a liquid ejecting apparatus including:
a first ejection section that includes a first piezoelectric element that is displaced in response to a drive signal and that is configured to eject a liquid in response to the displacement of the first piezoelectric element,
the inspection method comprising:
inspecting a state of the first ejection section based on a detection signal according to a potential of the first piezoelectric element in an inspection period included in a unit period when the drive signal is supplied to the first piezoelectric element in a drive period included in the unit period, wherein
the inspection of the state of the first ejection section is configured to be executed in a plurality of inspection modes including:
a first inspection mode in which the state of the first ejection section is inspected in a state in which the first ejection section is filled with the liquid, and
a second inspection mode in which the state of the first ejection section is inspected in a time shorter than that in the first inspection mode,
the drive signal
maintains a first potential in a first period of the unit period,
changes in potential from the first potential to a second potential in a second period, following the first period, of the unit period,
maintains the second potential in a third period, following the second period, of the unit period,
changes in potential from the second potential to the first potential in a fourth period, following the third period, of the unit period, and
maintains the first potential in a fifth period, following the fourth period, of the unit period,
the third period includes the inspection period,
the drive period does not include the inspection period and includes at least the second period, and
a time length of the second period in the first inspection mode is longer than a time length of the second period in the second inspection mode.

17. An inspection method for a liquid ejecting apparatus including:
a first ejection section that includes a first piezoelectric element that is displaced in response to a drive signal and that is configured to eject a liquid in response to the displacement of the first piezoelectric element; and
a second ejection section that includes a second piezoelectric element that is displaced in response to the drive signal and that is configured to eject the liquid in response to the displacement of the second piezoelectric element,
the inspection method comprising:
when the drive signal is supplied to the second piezoelectric element in a unit period, inspecting a state of the first ejection section based on a detection signal according to a potential of the first piezoelectric element in an inspection period included in the unit period, wherein
the inspection of the state of the first ejection section is configured to be executed in a plurality of inspection modes including:
a first inspection mode in which the state of the first ejection section is inspected in a state in which the first ejection section and the second ejection section are filled with the liquid, and
a second inspection mode in which the state of the first ejection section is inspected in a time shorter than that in the first inspection mode,
the drive signal
changes in potential from a first potential to a second potential in a first transition period of the unit period,
maintains the second potential in a maintenance period, following the first transition period, of the unit period, and
changes in potential from the second potential to the first potential in a second transition period, following the maintenance period, of the unit period,
the maintenance period includes the inspection period, and
a time length of the first transition period in the first inspection mode is longer than a time length of the first transition period in the second inspection mode.

18. The inspection method according to claim 13, further comprising:
outputting an inspection result indicating that the state of the first ejection section is abnormal when a change amount in potential of the first piezoelectric element in the inspection period is equal to or greater than a reference amount.
